(19) United States
(12) Patent Application Publication
(10) Pub. No.: US 2007/0100085 A1
(43) Pub. Date: May 3, 2007

(54) Amide-modified polymer compositions and sports equipment made using the compositions

(75) Inventors: Hyun Kim, Carlsbad, CA (US); Hong Jeon, Carlsbad, CA (US)

Correspondence Address: KLARQUIST SPARKMAN, LLP, 121 SW SALMON STREET, SUITE 1600, PORTLAND, OR, 97204, US

(73) Assignee: Taylor Made Golf Company, Inc.

(21) Appl. No.: 11/592,109

(22) Filed: Nov. 1, 2006

Related U.S. Application Data
(60) Provisional application No. 60/733,432, filed on Nov. 3, 2005.

(51) Int. Cl. C08C 19/22; A63B 37/12; A63B 37/02

(52) U.S. Cl. 525/374; 525/540; 473/371

(57) ABSTRACT

The present invention concerns polymer compositions to which a monomeric aliphatic, alicyclic, and/or aromatic amide, or amides, is added to advantageously modify the properties of such compositions for making sports equipment, such as golf balls. The amide is used in an amount effective to obtain desired composition properties, such as improved rheological properties, while maintaining or at least substantially maintaining properties of products made using the composition, such as the coefficient of restitution. The aliphatic or aromatic monomeric amide may be a primary amide, a secondary amide, a tertiary amide, a bis amide, and combinations thereof, and may have from about 5 to about 100 carbon atoms, more typically from about 10 to about 25 carbon atoms. Moreover, the amide may be saturated or may include one or more sites of unsaturation, such as at least one, and possibly plural double bonds that are substantially all trans, substantially all cis, or a mixture of cis and trans double bonds. One embodiment of a disclosed composition useful for making a golf ball comprises at least one polymer suitable for such use, and an amount of the amide effective to desirably modify the polymer properties. The composition may further include from about 1 to about 99 weight percent of at least one additional thermoplastic or thermoset polymeric material. The composition can be used to make any golf ball component, such as a golf ball core, at least one layer other than the core including the cover, or can be used to make more than one component of the golf ball, such as the core, an intermediate layer, and/or a golf ball cover. A method for forming a golf ball also is disclosed comprising providing an embodiment of the disclosed composition and forming at least one component of a golf ball comprising the composition.

### CROSS-REFERENCE TO RELATED APPLICATION

This application claims the benefit of the earlier filing date of U.S. Provisional Application No. 60/733,432, filed on Nov. 3, 2005. The entire disclosure of provisional application No. 60/733,432 is considered to be part of the disclosure of the accompanying application and is incorporated herein by reference.

### FIELD

The present application concerns embodiments of a composition useful for making sports equipment, such as golf balls and golf ball embodiments made using the composition.

### BACKGROUND

A. Golf Ball Construction and Composition

One-piece balls, molded from a homogeneous mass of material with a dimple pattern, are inexpensive and very durable, but do not provide great distance because of relatively high spin and low velocity. As a result, most modern golf balls generally comprise a core and at least one additional outer layer. Two-piece balls include a cover around a solid, often single-piece, spherical rubber core. Two-piece balls have high initial speeds but relatively low spin rates, and hence perform well for drives and other shots made using woods, but do not perform as well for shots made with short irons where distance is less important and high spin rate is desirable.

Ball performance can be further modified, particularly the travel distance and the feel transmitted to the golfer through the club, by including additional layers between the core and outer cover layer. A three-piece ball has one additional layer between the core and outer cover layer. Similarly, a four-piece ball results if two additional layers are introduced between the core and outer cover layer, and so on.

The materials used to make individual golf ball layers also significantly affect golf ball performance. Synthetic polymer chemistry has revolutionized both golf ball performance and manufacturing processes. Golf ball performance is affected by, for example, polymer hardness, compression, resilience and durability. Most modern golf balls now utilize core compositions made from synthetic rubbers based on polybutadiene, especially cis-1,4-polybutadiene. In order to tailor the properties of the core, the polybutadiene often is further formulated with crosslinking agents, such as sulfur or peroxides, or by irradiation, as well as co-crosslinking agents such as zinc diacrylate. In addition, the weight and hardness of the core may be further adjusted by incorporating various filler materials.

Like golf ball cores, golf ball covers and/or intermediate layers are sometimes made from rubber, such as naturally occurring balata rubber. Many players still favor this cover material as its softness allows them to achieve spin rates that provide more precise control of ball direction and distance, particularly on shorter approach shots. One deficiency of balata is that it is easily cut or sheared. Also, as with synthetic 1,4-polybutadiene rubber, balata rubber has relatively high viscosity at normal injection molding temperatures and thus is not easily adaptable to traditional thin-layer-forming injection molding techniques.

In addition to the polybutadiene-based synthetic rubbers, synthetic polyalkenamers are useful for making golf balls. In addition to a linear polymeric component, polyalkenamers contain a significant fraction of cyclic oligomer molecules, which lowers their viscosity. Compounds of this class can be produced in accordance with the teachings of U.S. Pat. Nos. 3,804,803, 3,974,092 and 4,950,826, the entire contents of all of which are incorporated herein by reference. Compositions for forming golf balls also are disclosed in applicants' copending provisional application No. 60/646,669, as well as applicants' provisional application entitled “Golf Ball Prepared From a Polyalkenamer/Polyamide Composition,” which was filed with the U.S. Patent Office on Aug. 8, 2005, both of which applications are incorporated herein by reference.

B. Golf Ball Compositions Comprising Polyamides

Golf balls comprising polyamides are known. For example, U.S. Pat. No. 6,485,378, states that “[s]uitable inner and outer core materials include thermosets, such as rubber, polybutadiene, polyisoprene; thermoplastics such as ionomer resins, polyamides or polyesters; or a thermoplastic elastomer.” However, applicants are unaware of any golf ball composition that includes polymeric compositions comprising monomeric aliphatic or aromatic amide(s).

C. Polymeric Compositions Comprising Slip Agents

Particular film compositions comprising particular amide slip agents are known. For example, trilayer films containing a polyolefin plastomer (POP) as one skin layer and LLDPE as the other two layers with erucamide [(13-cis-docosenoamide)-H₃C(CH₂)₁₁HC═CH(CH₂)₇CONH₂] incorporated in the POP layer have been made. See, Shuler et al., “Fate of Erucamide in Polyolefin Films at Elevated Temperature,” Polym. Eng. Sci. 44:2247-2253 (2004).

Erucamide is a migratory additive, and the relationship between erucamide surface concentration and the coefficient of friction (COF) of LLDPE films has been studied. See, for example, Ramirez, et al., Vinyl. Addit. Technol. 11:9-12 (2005). Erucamide (Crodamide ER) and oleamide (Crodamide Oreg.) migrate through the polymer to form a layer at the polymer surface that provides a slip or mold release effect. Slip performance may be closely linked to chemical structure. For example, the cis double bond at the center of the fatty chain in erucamide and oleamide appears vital for slip performance. If the double bond is altered to the trans orientation, moved to a different position in the fatty chain, or is removed completely to give the saturated analogs behenamide and stearamide, then slip performance is dramatically reduced, as discussed on the world wide web at http://www.chemsoc.org/chembytes/ezine/2002/birkett_jul02.htm.

Erucamide, also has been used in combination with polypropylene films. See, for example, http://www.bppetrochemicals.com.

Most commercial polymers are used with a cocktail of additives that collectively modify the properties of the polymer. For example, antioxidants, light stabilisers and fire retardants are expected to remain in the polymer throughout its service life, which requires solubility. Undesirable precipitation of such additives on the polymer surface is referred to as blooming. Conversely, erucamide's mold release and slip enhancing properties depend on incompatibility of the additive with the polymer and its migration to the surface, as discussed on the World Wide Web at http://www.nml.csir.co.za/news/20020711/index1.htm. Diffusion of erucamide in poly(laurolactam) (Nylon 12) (PA-12) has been studied within the temperature range of 343 to 353 K. See, www.interscience.wiley.com/cgi-bin/abstract/70000886/ABSTRACT.

Slip agents also are described in the patent literature. For example, U.S. Pat. No. 6,770,360 discusses using slip additives in a multilayer film having a thermoplastic core layer 16 and thermoplastic skin layers 18 and 20. Specifically, the '360 patent states:
The skin layer 18 is comprised of any thermoplastic polymer abrasion and scuff resistant as indicated above. In one embodiment, the skin layer is comprised of an ethylene-acrylic acid copolymer, ethylene-methacrylic acid copolymer, an ionomer derived from sodium, lithium or zinc and an ethylene/methacrylic acid copolymer, or a combination thereof. Any of the ethylene acrylic or methacrylic acid copolymers or ionomers described above as being useful in making the core layer 16 can be used. These copolymers and ionomers that are useful include the ionomers available from DuPont under the tradename Surlyn, the ethylene/methacrylic acid copolymers available from DuPont under the tradename Nucrel, and the ethylene/acrylic acid copolymers available from Dow Chemical under the tradename Primacor.
   The '360 patent, column 7, lines 37-52. The '360 patent also states that:
The skin layers 18 and 20 may contain antiblock and/or slip additives. These additives reduce the tendency of the film to stick together when it is in roll form. The antiblock additives include natural silica, diatomaceous earth, synthetic silica, glass spheres, ceramic particles, etc. The slip additives include primary amides such as stearamide, behenamide, oleamide, erucamide, and the like; secondary amides such as stearyl erucamide, erucyl erucamide, oleyl palimitamide, stearyl stearamide, erucyl stearamide, and the like; ethylene bisamides such as N,N′-ethylenebisstearamide, N,N′-ethylenebisolamide and the like; and combinations of any two or more of the foregoing amides. An example of a useful slip additive is available from Ampacet under the trade designation 10061; this product is identified as a concentrate containing 6% by weight of a stearamide slip additive. The antiblock and slip additives may be added together in the form of a resin concentrate. An example of such a concentrate is available from DuPont under the tradename Elvax CE9619-1. This resin concentrate contains 20% by weight silica, 7% by weight of an amide slip additive, and 73% by weight of Elvax 3170 (a product of DuPont identified as an ethylene/vinyl acetate copolymer having a vinyl acetate content of 18% by weight). The antiblock additive can be used at a concentration in the range of up to about 1% by weight, and in one embodiment about 0.01% to about 0.5% by weight. The slip additive can be used at a concentration in the range of up to about 1% by weight, and in one embodiment about 0.01% to about 0.5% by weight.

U.S. Pat. No. 6,812,276 discloses a thermoset composition comprising: a functionalized poly(arylene ether); an alkenyl aromatic monomer; and an acryloyl monomer. Such compositions may include erucamide as a lubricant. According to the '276 patent, such materials may be useful for making golf club shafts.

### SUMMARY

A need exists for new, modified polymer compositions that address undesirable characteristics of known formulations, such as the rheological properties of compositions used to make sports equipment. Disclosed embodiments of the present invention concern polymer compositions to which a monomeric aliphatic and/or aromatic amide or amides, such as erucamide, are added to advantageously modify the properties of such compositions. While erucamide has been used with particular polyolefins and nylon as a slip agent, to applicants' knowledge it has not been used as a polymer modifier for compositions used to make golf balls.

Disclosed embodiments of the composition typically comprise at least a first polymer material, such as a polyamide, and in certain embodiments a polyamide other than nylon, thermoplastic elastomers, thermoset elastomers, polyurethanes, bimodal ionomers, and combinations thereof, combined with at least one aliphatic, alicyclic, or aromatic amide. The amide is used in an amount, such as greater than 0.5 weight percent to about 50 weight percent based on the weight of the polymer, effective to obtain desired composition properties, such as improved rheological properties, while maintaining or at least substantially maintaining properties of products made using the composition, such as the coefficient of restitution. The composition can include mixtures of polymeric materials, and hence certain embodiments further comprise from about 1 to about 99 weight percent of an additional thermoplastic or thermoset polymer (based on the weight of the polymer).

A number of different amides are useful for modifying polymer composition properties as disclosed in the present application. For example, the aliphatic, alicyclic or aromatic monomeric amide may be a primary amide, a secondary amide, a tertiary amide, a bis amide, and combinations thereof, and may have from about 5 to about 100 carbon atoms, more typically from about 10 to about 25 carbon atoms. Moreover, the amide may be saturated or may include one or more sites of unsaturation, such as at least one and possibly plural double bonds. For amides having more than one double bond, the double bonds may be substantially all trans, substantially all cis, or may include a mixture of cis and trans double bonds. The amide can further include functional groups other than the amide functionality, such as hydroxyl, sulfhydryl, halo, glycidyl, carboxyl, anhydride, ether, sulfide, carbonyl, epoxide, and amine functional groups, and combinations of all such functional groups.

In one embodiment the composition comprises a fatty acid aliphatic amide. Particular examples of suitable amides, without limitation, include stearamide, behenamide, oleamide, erucamide, stearyl erucamide, erucyl erucamide, oleyl palimitamide, stearyl stearamide, erucyl stearamide, N,N′ethylenebisstearamide, N,N′ethylenebisolamide, carnauba wax amide, rice wax amide, montan wax amide, and combinations of any two or more of such amides.

Useful compositions can include materials other than the at least one polymer and the amide. For example, the composition may further comprise a cross-linking agent, including agents selected from sulfur compounds, peroxides, azides, maleimides, e-beam radiation, gamma-radiation; a co-cross-linking agent, such as zinc or magnesium salts of an unsaturated fatty acid having from about 3 to about 8 carbon atoms; a base resin; a peptizer; an accelerator; a UV stabilizer; a photostabilizer; a photoinitiator; a co-initiator; an antioxidant; a colorant; a dispersant; a mold release agent; a processing aid; a fiber; a filler, including a density adjusting filler, a nano-filler, an inorganic filler, an organic filler; a compound having a general formula (R₂N)ₘ—R′—(X(O)ₙOR_{y})ₘ, wherein R is selected from the group consisting of hydrogen, one or more C₁-C₂₀ aliphatic systems, one or more cycloaliphatic systems, one or more aromatic systems, R′ is a bridging group comprising one or more unsubstituted C₁-C₂₀ straight chain or branched aliphatic or alicyclic groups, one or more substituted straight chain or branched aliphatic or alicyclic groups, one or more aromatic groups, one or more oligomers each containing up to 12 repeating units, and when X is C or S or P, m is 1-3, when X=C, n=1 and y=1, when X=S, n=2 and y=, and when X=P, n=2 and y=2, and any and all combinations of materials satisfying the general formula; and any and all combinations of the materials other than the polymer and the amide.

One embodiment of a composition according to the present invention useful for making a golf ball comprises at least one polymer suitable for such use, and an amount of the monomeric aliphatic, alicyclic or aromatic amide effective to desirably modify the polymer properties. The composition may further include from about 1 to about 99 weight percent of an additional thermoplastic or thermoset polymeric material. Examples, without limitation, of suitable polymeric materials advantageously modified by the addition of the amide include synthetic and natural rubbers, thermoset polyurethanes and thermoset polyureas, unimodal ethylene/carboxylic acid copolymers, unimodal ethylene/carboxylic acid/carboxylate terpolymers, bimodal ethylene/carboxylic acid copolymers, bimodal ethylene/carboxylic acid/carboxylate terpolymers, unimodal ionomers, bimodal ionomers, modified unimodal ionomers, modified bimodal ionomers, thermoplastic and thermoset polyurethanes, thermoplastic and thermoset polyureas, polyamides, copolyamides, polyesters, copolyesters, polycarbonates, polyolefins, halogenated polyolefins, halogenated polyalkylenes, such as halogenated polyethylene, polyphenylene oxide, polyphenylene sulfide, diallyl phthalate polymer, polyimides, polyvinyl chloride, polyamide-ionomer, polyurethane-ionomer, polyvinyl alcohol, polyarylate, polyacrylate, polyphenylene ether, impact-modified polyphenylene ether, polystyrene, high impact polystyrene, acrylonitrile-butadiene-styrene copolymer styrene-acrylonitrile (SAN), acrylonitrile-styrene-acrylonitrile, styrene-maleic anhydride (S/MA) polymer, styrenic copolymer, functionalized styrenic copolymer, functionalized styrenic terpolymer, styrenic terpolymer, cellulose polymer, liquid crystal polymer (LCP), ethylene-propylene-diene terpolymer (EPDM), ethylene-vinyl acetate copolymers (EVA), ethylene-propylene copolymer, ethylene vinyl acetate, polyurea, polysiloxane. Particular embodiments of disclosed golf ball comprise a polymer selected from the group consisting of polyamides, polyamide elastomers, ionomers, and combinations thereof.

The composition can be used to make any golf ball component, such as a golf ball core, at least one layer other than the core including the cover, or can be used to make more than one component of the golf ball, such as the core, an intermediate layer, and/or a golf ball cover. For golf balls comprising a core, at least one intermediate layer and an outer cover layer, the polymeric material of the core, the at least one intermediate layer and/or the outer cover layer may further comprise materials in addition to the composition, such as a cross-linking agent selected from sulfur compounds, peroxides, azides, maleimides, e-beam radiation, gamma-radiation, a co-cross-linking agent comprising zinc or magnesium salts of an unsaturated fatty acid having from about 3 to about 8 carbon atoms, a base resin, a peptizer, an accelerator, a UV stabilizer, a photostabilizer, a photoinitiator, a co-initiator, an antioxidant, a colorant, a dispersant, a mold release agent, a processing aid, a fiber, a filler, a density adjusting filler, a nano-filler, an inorganic filler, an organic filler, a compound having a general formula (R₂N)ₘ—R′—(X(O)ₙOR_{y})ₘ, wherein R is selected from the group consisting of hydrogen, one or more C₁-C₂₀ aliphatic systems, one or more cycloaliphatic systems, one or more aromatic systems, R′ is a bridging group comprising one or more unsubstituted C₁-C₂₀ straight chain or branched aliphatic or alicyclic groups, one or more substituted straight chain or branched aliphatic or alicyclic groups, one or more aromatic groups, one or more oligomers each containing up to 12 repeating units, and when X is C or S or P, m is 1-3, when X=C, n=1 and y=1, when X=S, n=2 and y=1, and when X=P, n=2 and y=2, and any and all combinations of such materials, satisfying the general formula and combinations thereof. For golf balls comprising multiple layers, the hardness may increase outwards from the core to the cover, or alternatively may decrease outwards from the core to the cover. Alternatively, balls can have such multi-layered internal structures with a cover, which can be softer or harder than the outer-most internal layer beneath the cover.

A method for forming a golf ball also is disclosed. The method typically comprises providing an embodiment of the disclosed composition and forming at least one component of a golf ball comprising the composition.

### BRIEF DESCRIPTION OF THE DRAWINGS

FIG. 1 is a schematic cross section of a two-piece golf ball.

FIG. 2 is a schematic cross section of a three-piece golf ball.

### DETAILED DESCRIPTION

### I. Introduction and Definitions

The following definitions are provided to aid the reader, and are not intended to define terms to have a scope that would be narrower than would be understood by a person of ordinary skill in the art of golf ball composition and manufacture.

Any numerical values recited herein include all values from the lower value to the upper value. All possible combinations of numerical values between the lowest value and the highest value enumerated herein are expressly included in this application.

As used herein, the term “core” is intended to mean the elastic center of a golf ball, which may have a unitary construction. Alternatively the core itself may have a layered construction having a spherical “center” and additional “core layers,” with such layers being made of the same material or a different material from the core center.

The term “cover” is meant to include any layer of a golf ball that surrounds the core. Thus a golf ball cover may include both the outermost layer and also any intermediate layers, which are disposed between the golf ball center and outer cover layer. “Cover” may be used interchangeably with the term “cover layer”.

The term “intermediate layer” may be used interchangeably with “mantle layer,” “inner cover layer” or “inner cover” and is intended to mean any layer(s) in a golf ball disposed between the core and the outer cover layer.

The term “(meth)acrylic acid copolymers” is intended to mean copolymers of methacrylic acid and/or acrylic acid.

The term “(meth)acrylate” is intended to mean an ester of methacrylic acid and/or acrylic acid.

The term “fully-interpenetrating network” refers to a network that includes two independent polymer components that penetrate each other, but are not covalently bonded to each other.

The term “semi-interpenetrating network” refers to a network that includes at least one polymer component that is linear or branched and interspersed in the network structure of at least one of the other polymer components.

The term “pseudo-crosslinked network” refers to materials that have crosslinking, but, unlike chemically vulcanized elastomers, pseudo-crosslinked networks are formed in-situ, not by covalent bonds, but instead by ionic clustering of the reacted functional groups, which clustering may disassociate at elevated temperatures.

In the case of a ball with two intermediate layers, the term “inner intermediate layer” may be used interchangeably herein with the terms “inner mantle” or “inner mantle layer” and is intended to mean the intermediate layer of the ball positioned nearest to the core.

Again, in the case of a ball with two intermediate layers, the term “outer intermediate layer” may be used interchangeably herein with the terms “outer mantle” or “outer mantle layer” and is intended to mean the intermediate layer of the ball which is disposed nearest to the outer cover layer.

The term “outer cover layer” is intended to mean the outermost cover layer of the golf ball on which, for example, the dimple pattern, paint and any writing, symbol, etc. is placed. If, in addition to the core, a golf ball comprises two or more cover layers, only the outermost layer is designated the outer cover layer. The remaining layers may be designated intermediate layers. The term outer cover layer is interchangeable with the term “outer cover”.

“Polymer precursor material” refers to any material that can be further processed to form a final polymer material of a manufactured golf ball, such as, by way of example and not limitation, monomers that can be polymerized, or a polymerized or partially polymerized material that can undergo additional processing, such as crosslinking.

The term “bimodal polymer” refers to a polymer comprising two main fractions and more specifically to the form of the polymer's molecular weight distribution curve, i.e., the appearance of the graph of the polymer weight fraction as function of its molecular weight. When the molecular weight distribution curves from these fractions are superimposed onto the molecular weight distribution curve for the total resulting polymer product, that curve will show two maxima or at least be distinctly broadened in comparison with the curves for the individual fractions. Such a polymer product is called bimodal. It is to be noted here that also the chemical compositions of the two fractions also may be different.

Similarly the term “unimodal polymer” refers to a polymer comprising one main fraction and more specifically to the form of the polymer's molecular weight distribution curve, i.e., the molecular weight distribution curve for the total polymer product shows only a single maximum.

The term “polyalkenamer” is used interchangeably herein with the term “polyalkenamer rubber” and means a polymer of one or more alkenes, including cycloalkenes, having from 5-20, preferably 5-15, most preferably 5-12 ring carbon atoms. The polyalkenamers may be prepared by any suitable method including ring opening metathesis polymerization of one or more cycloalkenes in the presence of organometallic catalysts as described in U.S. Pat. Nos. 3,492,245, and 3,804,803, the entire contents of both of which are incorporated herein by reference.

A “thermoplastic material” is generally defined as a material that is capable of softening or fusing when heated and of hardening again when cooled. Thermoplastic polymer chains often are not cross-linked, but the term “thermoplastic” as used herein may refer to materials that initially act as thermoplastics, such as during an initial extrusion process, but which also may be crosslinked, such as during a compression molding step to form a final structure.

A “fiber” is a general term and the definition provided by Engineered Materials Handbook, Vol. 2, “Engineering Plastics”, published by A.S.M. International, Metals Park, Ohio, USA, is relied upon to refer to filamentary materials with a finite length that is at least 100 times its diameter, which typically is 0.10 to 0.13 mm (0.004 to 0.005 in.). Fibers can be continuous or specific short lengths (discontinuous), normally no less than 3.2 mm (⅛ in.). Although fibers according to this definition are preferred, fiber segments, i.e., parts of fibers having lengths less than the aforementioned also are considered to be encompassed by the invention. Thus, the terms “fibers” and “fiber segments” are used herein. “Fibers or fiber segments” and “fiber elements” are used to encompass both fibers and fiber segments. Embodiments of the golf ball components described herein may include fibers including, by way of example and without limitation, glass fibers, such as E fibers, Cem-Fil filament fibers, and 204 filament strand fibers; carbon fibers, such as graphite fibers, high modulus carbon fibers, and high strength carbon fibers; asbestos fibers, such as chrysotile and crocidolite; cellulose fibers; aramid fibers, such as Kevlar, including types PRD 29 and PRD 49; and metallic fibers, such as copper, high tensile steel, and stainless steel. In addition, single crystal fibers, potassium titanate fibers, calcium sulphate fibers, and fibers or filaments of one or more linear synthetic polymers such as Terylene, Dacron, Perlon, Orion, Nylon, including Nylon type 242, are contemplated. Polypropylene fibers, including monofilament and fibrillated fibers are also contemplated. Golf balls according to the present invention also can include any combination of such fibers. Fibers used in golf ball components are described more fully in Kim et al. U.S. Pat. No. 6,012,991, which is incorporated herein by reference.

A “nanocomposite” is defined as a polymer matrix having nanofiller within the matrix. Nanocomposite materials and golf balls made comprising nanocomposite materials are disclosed in Kim et al., U.S. Pat. No. 6,794,447, and U.S. Pat. No. 5,962,553 to Ellsworth, U.S. Pat. No. 5,385,776 to Maxfield et al., and U.S. Pat. No. 4,894,411 to Okada et al., which are incorporated herein by reference in their entirety. Inorganic nanofiller materials generally are made from clay, and may be coated by a suitable compatibilizing agent, as discussed below in further detail. The compatibilizing agent allows for superior linkage between inorganic and organic material, and it also can account for the hydrophilic nature of the inorganic nanofiller material and the possibly hydrophobic nature of the polymer. Nanofiller particles typically, but not necessarily, are approximately 1 nanometer (nm) thick and from about 100 to about 1000 nm across, and hence have extremely high surface area, resulting in high reinforcement efficiency to the material at low particle loading levels. The sub-micron-sized particles enhance material properties, such as the stiffness of the material, without increasing its weight or opacity and without reducing the material's low-temperature toughness. Materials incorporating nanofiller materials can provide these property improvements at much lower densities than those incorporating conventional fillers.

Nanofillers can disperse within a polymer matrix in three ways. The nanofiller may stay undispersed within the polymer matrix. Undispersed nanofillers maintain platelet aggregates within the polymer matrix and have limited interaction with the polymer matrix. As the nanofiller disperses into the polymer matrix, the polymer chains penetrate into and separate the platelets. When viewed by transmission electron microscopy or x-ray diffraction, the platelet aggregates are expanded relative to undispersed nanofiller. Nanofillers at this dispersion level are referred to as being intercalated. A fully dispersed nanofiller is said to be exfoliated. An exfoliated nanofiller has the platelets fully dispersed throughout the polymer matrix; the platelets may be dispersed unevenly but preferably are dispersed substantially evenly.

Nanocomposite materials are materials incorporating from about 0.1% to about 20%, preferably from about 0.1% to about 15%, and most preferably from about 0.1% to about 10% nanofiller potentially reacted into and preferably substantially evenly dispersed through intercalation or exfoliation into the structure of an organic material, such as a polymer, to provide strength, temperature resistance, and other property improvements to the resulting composite. Descriptions of particular nanocomposite materials and their manufacture can be found in U.S. Pat. No. 5,962,553 to Ellsworth, U.S. Pat. No. 5,385,776 to Maxfield et al., and U.S. Pat. No. 4,894,411 to Okada et al. Examples of nanocomposite materials currently marketed include M1030D, manufactured by Unitika Limited, of Osaka, Japan, and 1015C2, manufactured by UBE America of New York, N.Y.

When nanocomposites are blended with other polymer systems, the nanocomposite may be considered a type of nanofiller concentrate. However, a nanofiller concentrate may be more generally a polymer into which nanofiller is mixed; a nanofiller concentrate does not require that the nanofiller has reacted and/or dispersed evenly into the carrier polymer. When used in the manufacture of golf balls, nanocomposite materials can be blended effectively into ball compositions at a typical weight percentage, without limitation, of from about 1% to about 50% of the total composition used to make a golf ball component, such as a cover or core, by weight.

### II. Golf Ball Composition and Construction

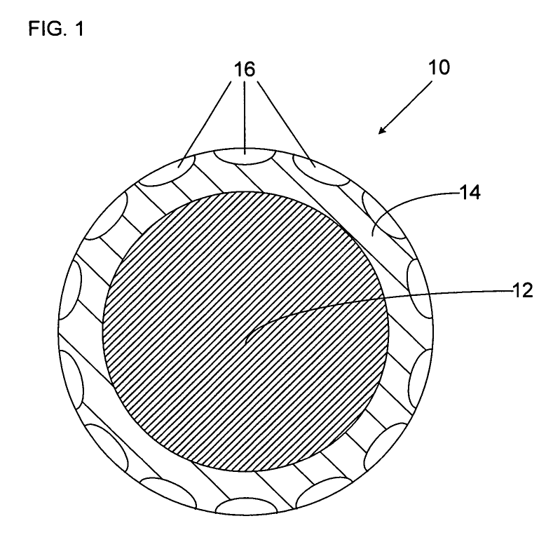

FIG. 1 illustrates a two-piece golf ball 10 comprising a solid center or core 12, and an outer cover layer 14. Golf balls also typically include plural dimples 16 formed in the outer cover and arranged in various desired patterns.

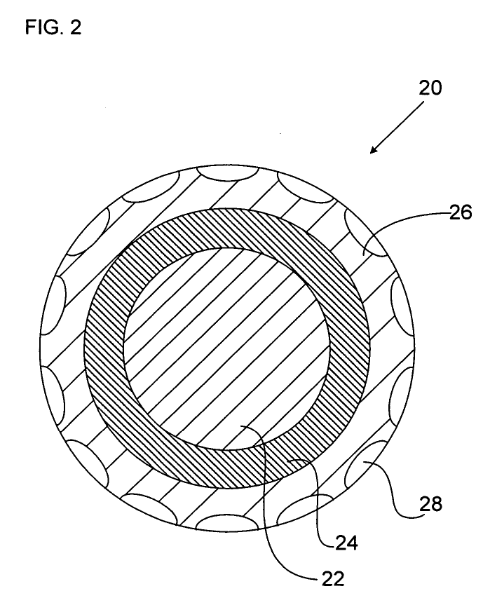

FIG. 2 illustrates a 3-piece golf ball 20 comprising a core 22, an intermediate layer 24 and an outer cover layer 26. Golf ball 20 also typically includes plural dimples 28 formed in the outer cover layer 26 and arranged in various desired patterns. Although FIGS. 1 and 2 illustrate only two- and three-piece golf ball constructions, golf balls of the present invention may comprise from 0 to at least 5 intermediate layer(s), preferably from 0 to 3 intermediate layer(s), more preferably from 1 to 3 intermediate layer(s), and most preferably 1 to 2 intermediate layer(s).

The present invention can be used to form golf balls of any desired size. “The Rules of Golf” by the USGA dictate that the size of a competition golf ball must be at least 1.680 inches in diameter; however, golf balls of any size can be used for leisure golf play. The preferred diameter of the golf balls is from about 1.680 inches to about 1.800 inches. Oversize golf balls with diameters above about 1.760 inches to as big as 2.75 inches also are within the scope of the invention.

A. Core

The core of the balls of the present invention have a diameter of from about 0.5 to about 1.62 inches, preferably from about 0.7 to about 1.60 inches, more preferably from about 1 to about 1.58 inches, yet more preferably from about 1.20 to about 1.54 inches, and most preferably from about 1.40 to about 1.52 inches.

In another preferred embodiment, the golf ball core has at least one core layer on the center core, the layer having a thickness of from about 0.01 to about 1.14 inch, preferably from about 0.02 to about 1.12 inch, more preferably from about 0.03 to about 1.10 inch and most preferably from about 0.04 to about 1 inch.

In still another embodiment, two-piece balls are disclosed comprising a core and a cover having a thickness of from about 0.01 to about 0.20 inch, preferably from about 0.02 to about 0.15 inch, more preferably from about 0.03 to about 0.10 inch and most preferably from about 0.03 to about 0.07 inch. The cover typically has a hardness greater than about 25, preferably greater than about 30, and typically greater than about 40 Shore D. The ball typically has a PGA ball compression greater than about 40, preferably greater than 50, more preferably greater than about 60, most preferably greater than about 70.

The golf ball cores of the present invention typically have a PGA compression of from about 30 to about 190, preferably from about 40 to about 160, typically from about 50 to about 130, and most preferably from about 60 to about 100.

The Shore D hardness of the core center and core layers made according to the present invention may vary from about 20 to about 90, typically from about 30 to about 80, and even more typically from about 40 to about 70.

B. Intermediate Layer(s) and Cover Layer

In one preferred embodiment, the golf ball of the present invention is a three-piece ball having a core and/or at least one layer comprising a polymeric material modified as disclosed herein.

In another preferred embodiment of the present invention, the golf ball of the present invention is a four-piece ball having a core and/or at least one layer comprising a polymeric material modified as disclosed herein.

The one or more intermediate layers of the golf balls of the present invention has a thickness of from about 0.01 to about 0.20 inch, preferably from about 0.02 to about 0.15 inch, more preferably from about 0.03 to about 0.10 inch and most preferably from about 0.03 to about 0.06 inch.

The one or more intermediate layers of the golf balls of the present invention also has a Shore D hardness greater than about 25, preferably greater than about 30, and typically greater than about 40.

The one or more intermediate layers of the golf balls of the present invention also has a flexural modulus from about 5 to about 500, preferably from about 15 to about 300, more preferably from about 20 to about 200, and most preferably from about 25 to about 100 kpsi.

The cover layer of the balls of the present invention has a thickness of from about 0.01 to about 0.10, preferably from about 0.02 to about 0.08, more preferably from about 0.03 to about 0.07 inch.

The cover layer of the balls of the present invention has a Shore D hardness of from about 30 to about 75, preferably from about 30 to about 70, more preferably from about 45 to about 65.

The coefficient of restitution (COR) is an important physical attribute of golf balls. The coefficient of restitution is the ratio of the relative velocity between two objects after direct impact to the relative velocity before impact. As a result, the COR can vary from 0 to 1, with 1 being a perfectly or completely elastic collision and 0 being a perfectly or completely inelastic collision. Since the COR directly influences the ball's initial velocity after club collision and travel distance, golf ball manufacturers are interested in this characteristic for designing and testing golf balls.

One conventional technique for measuring COR uses a golf ball or golf ball subassembly, air cannon, and a stationary steel plate. The steel plate provides an impact surface weighing about 100 pounds or about 45 kilograms. A pair of ballistic light screens, which measure ball velocity, are spaced apart and located between the air cannon and the steel plate. The ball is fired from the air cannon toward the steel plate over a range of test velocities from 50 ft/s to 180 ft/sec. As the ball travels toward the steel plate, it activates each light screen so that the time at each light screen is measured. This provides an incoming time period proportional to the ball's incoming velocity. The ball impacts the steel plate and rebounds through the light screens, which again measure the time period required to transit between the light screens. This provides an outgoing transit time period proportional to the ball's outgoing velocity. The coefficient of restitution can be calculated by the ratio of the outgoing transit time period to the incoming transit time period, COR=T_{Out}/Tᵢₙ.

Another COR measuring method uses a titanium disk. The titanium disk, intending to simulate a golf club, is circular, has a diameter of about 4 inches, and has a mass of about 200 grams. The impact face of the titanium disk also may be flexible and has its own coefficient of restitution, as discussed further below. The disk is mounted on an X-Y-Z table so that its position can be adjusted relative to the launching device prior to testing. A pair of ballistic light screens are spaced apart and located between the launching device and the titanium disk. The ball is fired from the launching device toward the titanium disk at a predetermined test velocity. As the ball travels toward the titanium disk, it activates each light screen, so that the time period to transit between the light screens is measured. This provides an incoming transit time period proportional to the ball's incoming velocity. The ball impacts the titanium disk, and rebounds through the light screens which measure the time period to transit between the light screens. This provides an outgoing transit time period proportional to the ball's outgoing velocity. The COR can be calculated from the ratio of the outgoing time period to the incoming time period along with the mass of the disk (Me) and ball (Mb): COR=(Tout/Tin)×(Me+Mb)+MbMe.

The COR depends on the golf ball construction as well as the chemical composition of the various layers. Monomeric aliphatic, alicyclic and/or aromatic amides are added to polymeric compositions to desirably affect certain physical properties of such compositions, particularly features associated with processing such compositions, including melt-flow properties, while substantially maintaining COR values. For compositions comprising ionomers, such as SURLYN®-based compositions, the COR is substantially maintained relative to SURLYN®-based compositions that do not have monomeric aliphatic, alicyclic and/or aromatic amide additives. For example, compositions comprising SURLYN® 9910 and no monomeric aliphatic, alicyclic and/or aromatic amide additive have a COR value of about 0.697. Particular working embodiments of SURLYN®9910-based compositions comprising monomeric aliphatic, alicyclic and/or aromatic amide additives, such as erucamide, have a COR value typically greater than 0.6. More specifically, SURLYN® 9910-based compositions typically have a COR value greater than 0.67 at amide modifying amounts of 10 pph or less, greater than or equal to about 0.68 at amide modifying amounts of 7 pph or less, and greater than or equal to 0.69 at amide modifying amounts of 5 pph or less. Thus, for SURLYN® 9910-based compositions having 10 pph or less of a monomeric aliphatic and/or aromatic amide additive, such as erucamide, the COR value was reduced by less than 3%, and typically less than or equal to 2.6%. At the same time, the processability of Surlyn® 9910 was greatly improved, as shown by the increase in melt flow index from 6.9 g/10 minutes for non-modified Surlyn® 9910 up to 18.5 g/10 minutes for SURLYN® 9910-based compositions having 10% by weight of a monomeric aliphatic and/or aromatic amide additive. Also, the material hardness of Surlyn® 9910 was decreased from 65 Shore D without any amide-modification to 60 D with 3 pph erucamide added, 57 D with 7 pph erucamide added, and 55 D with 10 pph of erucamide added. Typically, the hardness of an ionomer is adjusted either by addition of soft terpolymeric ionomer or by addition of other soft elastomer. However, in this case with erucamide, the hardness of Surlyn® 9910 was decreased without adding any other polymer having lower hardness than Surlyn® 9910. The similar behavior or benefit was observed on flexural modulus, which decreased on amide modification.

Thus, the ability to maintain COR allows golf ball performance to be maintained while allowing for additional adjustments in ball layer material properties.

Similarly, working embodiments comprising SURLYN® 9150 and no monomeric aliphatic, alicyclic and/or aromatic amide additive have a COR value of about 0.71. Particular working embodiments of SURLYN® 9150-based compositions comprising 5 pph or less monomeric aliphatic, alicyclic and/or aromatic amide additives according to the present invention have a COR value typically greater than or equal to 0.669. Thus, for SURLYN® 9150-based compositions having 5 pph or less of a monomeric aliphatic, alicyclic and/or aromatic amide additive, the COR value was reduced by less than 6%.

Working embodiments comprising SURLYN® 8150 and no monomeric aliphatic and/or aromatic amide additive have a COR value of about 0.766. Particular working embodiments of SURLYN® 8150-based compositions comprising 5 pph or less monomeric aliphatic, alicyclic and/or aromatic amide additives according to the present invention have a COR value typically greater than or equal to 0.748. Thus, for SURLYN® 8150-based compositions having 5 pph or less of a monomeric aliphatic, alicyclic and/or aromatic amide additive, the COR value was reduced by less than 3%, and typically less than or equal to 2.4%.

Working embodiments also have been made with compositions comprising mixtures of ionomeric polymers, such as mixtures comprising SURLYN® 8150 and SURLYN® 9150. Particular working embodiments of SURLYN® 8150-/9150-based compositions and no monomeric aliphatic, alicyclic and/or aromatic amide additive have a COR value of about 0.785. Particular working embodiments of SURLYN® 8150-/9150-based compositions comprising 7 pph or less monomeric aliphatic, alicyclic and/or aromatic amide additive(s), such as erucamide, have a COR value typically greater than or equal to 0.76, and greater than or equal to 0.77 for compositions comprising 5 pph or less monomeric aliphatic, alicyclic and/or aromatic amide additive. Thus, for SURLYN® 8150-/9150-based compositions having 7 pph or less of a monomeric aliphatic, alicyclic and/or aromatic amide additive, such as erucamide, the COR value is reduced by less than or equal to 2.4%.

Working embodiments also have been made using polyalkenamer-modified compositions, such as a mixture comprising (1) copolymers of dodecanedioic acid with 4,4′-methylenebis(2-methylcyclohexanamine) (also known as cyclohexanamine, 4,4′-methylenebis(2-methylcyclohexanamine), commercially available as GRILAMID TR90 from EMS Chemie; and (2) VESTENAMER® 8012, which is a polyoctenamer commercially available from Degussa AG of Dusseldorf Germany. By way of example, a composition comprising GRILAMID TR90 with 10 pph VESTENAMER® 8012 and no monomeric aliphatic, alicyclic and/or aromatic amide additive had a COR of 0.793. The same composition comprising 3 pph or less of a monomeric aliphatic, alicyclic and/or aromatic amide additive, such as erucamide, had a COR of 0.799. Thus, by adding a monomeric aliphatic and/or aromatic amide additive, such as erucamide, the COR increased for such compositions.

### III. Polymeric Materials

Disclosed embodiments of the present invention particularly concern a method for making a golf ball where at least one layer of the ball comprises a polymeric composition modified as disclosed herein. The composition can be prepared by any suitable process, such as single screw extrusion, twin-screw extrusion, banbury mixing, two-roll mill mixing, dry blending, by using a master batch, or any combination of these techniques. The layers may be made by any suitable process, including extrusion, such as is disclosed in assignee's copending application No. 60/699,303, which is incorporated herein by reference, compression molding, injection molding, reaction injection molding, coating, casting, dipping, or combinations thereof.

Any processable polymeric material or mixture of polymeric materials that is useful for forming a golf ball core or layer that is now known or hereafter developed, which can be advantageously modified by the addition of a monomeric aliphatic or aromatic amide or amides, can be used to form useful compositions, such as compositions useful for manufacturing golf balls.

The compositions used to prepare golf balls according to the present invention comprise from about 0.1 to 99.9 wt %, of one or more polymers useful for forming a golf ball layer, the remaining portion of the composition including at least one aliphatic and/or aromatic monomeric amide modifying agent such as, by way of example and without limitation, a fatty acid amide agent useful for modifying polymers. The polymers may be made by methods known to a person of ordinary skill in the art, or many may be obtained commercially.

The following polymeric materials are provided solely as examples of materials useful for forming golf ball cores, intermediate layers, and/or cover layers. A person of ordinary skill in the art will recognize that the present invention is not limited solely to those materials listed herein by way of example. Moreover, a person of ordinary skill in the art also will recognize that various combinations of such materials can be used to form the core, intermediate layer(s) and/or outer cover layer.

Additional guidance for selecting materials useful for making golf balls according to the disclosed embodiments is provided by considering those physical properties desirable for making golf balls. In addition to the exemplary list of materials provided herein, a person of ordinary skill in the art might consider compression, hardness, density, flexural modulus, elasticity, COR, impact durability, tensile properties, melt flow index, acoustic behavior, compatibility, processability, etc., in view of values stated herein for such properties, values that are typical in the field, or values that otherwise would be known to a person of ordinary skill in the field.

A. General Description of Polymeric Materials

Polymeric materials generally considered useful for making golf balls according to the process of the present invention include, without limitation, synthetic and natural rubbers, thermoset polymers such as thermoset polyurethanes and thermoset polyureas, as well as thermoplastic polymers including thermoplastic elastomers such as metallocene catalyzed polymer, unimodal ethylene/carboxylic acid copolymers, unimodal ethylene/carboxylic acid/carboxylate terpolymers, bimodal ethylene/carboxylic acid copolymers, bimodal ethylene/carboxylic acid/carboxylate terpolymers, unimodal ionomers, bimodal ionomers, modified unimodal ionomers, modified bimodal ionomers, thermoplastic and thermoset polyurethanes, thermoplastic and thermoset polyureas, polyamides, copolyamides, polyesters, copolyesters, polycarbonates, polyolefins, halogenated (e.g. chlorinated) polyolefins, halogenated polyalkylene compounds, such as halogenated polyethylene [e.g. chlorinated polyethylene (CPE)], polyalkenamer, polyphenylene oxides, polyphenylene sulfides, diallyl phthalate polymers, polyimides, polyvinyl chlorides, polyamide-ionomers, polyurethane-ionomers, polyvinyl alcohols, polyarylates, polyacrylates, polyphenylene ethers, impact-modified polyphenylene ethers, polystyrenes, high impact polystyrenes, acrylonitrile-butadiene-styrene copolymers, styrene-acrylonitriles (SAN), acrylonitrile-styrene-acrylonitriles, styrene-maleic anhydride (S/MA) polymers, styrenic copolymers, functionalized styrenic copolymers, functionalized styrenic terpolymers, styrenic terpolymers, cellulosic polymers, liquid crystal polymers (LCP), ethylene-propylene-diene terpolymers (EPDM), ethylene-vinyl acetate copolymers (EVA), ethylene-propylene copolymers, ethylene vinyl acetates, polyureas, and polysiloxanes and any and all combinations thereof.

More specific examples of particular polymeric materials useful for making golf ball cores, optional intermediate layer(s) and outer covers, again without limitation, are provided below.

B. Polyalkenamers

Examples of suitable polyalkenamer rubbers are polypentenamer rubber, polyheptenamer rubber, polyoctenamer rubber, polydecenamer rubber and polydodecenamer rubber. For further details concerning polyalkenamer rubber, see Rubber Chem. & Tech., Vol. 47, page 511-596, 1974, which is incorporated herein by reference. Polyoctenamer rubbers are commercially available from Degussa AG of Dusseldorf, Germany, and sold under the trademark VESTENAMER®. Two grades of the VESTENAMER® trans-polyoctenamer are commercially available: VESTENAMER 8012 designates a material having a trans-content of approximately 80% (and a cis-content of 20%) with a melting point of approximately 54° C.; and VESTENAMER 6213 designates a material having a trans-content of approximately 60% (cis-content of 40%) with a melting point of approximately 30° C. Both of these polymers have a double bond at every eighth carbon atom in the ring.

The polyalkenamer rubber preferably contains from about 50 to about 99, preferably from about 60 to about 99, more preferably from about 65 to about 99, even more preferably from about 70 to about 90 percent of its double bonds in the trans-configuration. The preferred form of the polyalkenamer for use in the practice of the invention has a trans content of approximately 80%; however, compounds having other ratios of the cis- and trans-isomeric forms of the polyalkenamer also can be obtained by blending available products for use in the invention.

The polyalkenamer rubber has a molecular weight (as measured by GPC) from about 10,000 to about 300,000, preferably from about 20,000 to about 250,000, more preferably from about 30,000 to about 200,000, even more preferably from about 50,000 to about 150,000.

The polyalkenamer rubber has a degree of crystallization (as measured by DSC secondary fusion) from about 5% to about 70%, preferably from about 6% to about 50%, more preferably from about from 6.5% to about 50%, even more preferably from about from 7% to about 45%.

More preferably, the polyalkenamer rubber used in the present invention is a polymer prepared by polymerization of cyclooctene to form a trans-polyoctenamer rubber as a mixture of linear and cyclic macromolecules.

Prior to its use in the golf balls of the present invention, the polyalkenamer rubber may be further formulated with one or more of the following blend components:

1. Polyalkenamer Cross-Linking Agents

Any crosslinking or curing system typically used for rubber crosslinking may be used to crosslink the polyalkenamer rubber used in the present invention. Satisfactory crosslinking systems are based on sulfur-, peroxide-, azide-, maleimide- or resin-vulcanization agents, which may be used in conjunction with a vulcanization accelerator. Examples of satisfactory crosslinking system components are zinc oxide, sulfur, organic peroxide, azo compounds, magnesium oxide, benzothiazole sulfenamide accelerator, benzothiazyl disulfide, phenolic curing resin, m-phenylene bis-maleimide, thiuram disulfide and dipentamethylene-thiuram hexasulfide.

More preferable cross-linking agents include peroxides, sulfur compounds, as well as mixtures of these. Non-limiting examples of suitable cross-linking agents include primary, secondary, or tertiary aliphatic or aromatic organic peroxides. Peroxides containing more than one peroxy group can be used, such as 2,5-dimethyl-2,5-di(tert-butylperoxy)hexane and 1,4-di-(2-tert-butyl peroxyisopropyl)benzene. Both symmetrical and asymmetrical peroxides can be used, for example, tert-butyl perbenzoate and tert-butyl cumyl peroxide. Peroxides incorporating carboxyl groups also are suitable. The decomposition of peroxides used as cross-linking agents in the present invention can be brought about by applying thermal energy, shear, irradiation, reaction with other chemicals, or any combination of these. Both homolytically and heterolytically decomposed peroxide can be used in the present invention. Non-limiting examples of suitable peroxides include: diacetyl peroxide; di-tert-butyl peroxide; dibenzoyl peroxide; dicumyl peroxide; 2,5-dimethyl-2,5-di(benzoylperoxy)hexane; 1,4-bis-(t-butylperoxyisopropyl)benzene; t-butylperoxybenzoate; 2,5-dimethyl-2,5-di-(t-butylperoxy)hexyne-3, such as Trigonox 145-45B, marketed by Akzo Nobel Polymer Chemicals of Chicago, Ill.; 1,1-bis(t-butylperoxy)-3,3,5 tri-methylcyclohexane, such as Varox 231-XL, marketed by R.T. Vanderbilt Co., Inc., of Norwalk, Conn.; and di-(2,4-dichlorobenzoyl)peroxide.

The cross-linking agents are blended with the polymeric material in effective amounts, which typically vary in total amounts of from about 0.05 part to about 5 parts, more preferably about 0.2 part to about 3 parts, and most preferably about 0.2 part to about 2 parts, by weight of the cross-linking agents per 100 parts by weight of the polyalkenamer rubber.

Each peroxide cross-linking agent has a characteristic decomposition temperature at which 50% of the cross-linking agent has decomposed when subjected to that temperature for a specified time period (t_{1/2}). For example, 1,1-bis-(t-butylperoxy)-3,3,5-tri-methylcyclohexane at t_{1/2}=0.1 hr has a decomposition temperature of 138° C. and 2,5-dimethyl-2,5-di-(t-butylperoxy)hexyne-3 at t_{1/2}=0.1 hr has a decomposition temperature of 182° C. Two or more cross-linking agents having different characteristic decomposition temperatures at the same t_{1/2} may be blended in the composition. For example, where at least one cross-linking agent has a first characteristic decomposition temperature less than 150° C., and at least one cross-linking agent has a second characteristic decomposition temperature greater than 150° C., the composition weight ratio of the at least one cross-linking agent having the first characteristic decomposition temperature to the at least one cross-linking agent having the second characteristic decomposition temperature can range from 5:95 to 95:5, or more preferably from 10:90 to 50:50.

Besides the use of chemical cross-linking agents, exposure of the polyalkenamer rubber composition to radiation also can serve as a cross-linking agent. Radiation can be applied to the polyalkenamer rubber mixture by any known method, including using microwave or gamma radiation, or an electron beam device. Additives may also be used to improve radiation-induced crosslinking of the polyalkenamer rubber.

2. Co-Cross-Linking Agent

The polyalkenamer rubber may also be blended with a co-cross-linking agent, which may be a metal salt of an unsaturated carboxylic acid. Examples of these include zinc and magnesium salts of unsaturated fatty acids having from about 3 to about 8 carbon atoms, such as acrylic acid, methacrylic acid, maleic acid, fumaric acid and palmitic acid, with the zinc salts of acrylic and methacrylic acid being preferred, and with zinc diacrylate being most preferred. The unsaturated carboxylic acid metal salt can be blended in the polyalkenamer rubber either as a preformed metal salt, or by introducing an α,β-unsaturated carboxylic acid and a metal oxide or hydroxide into the polyalkenamer rubber composition, and allowing them to react to form the metal salt. The unsaturated carboxylic acid metal salt can be blended in any desired amount, but preferably in amounts of about 10 parts to about 100 parts by weight of the unsaturated carboxylic acid per 100 parts by weight of the polyalkenamer rubber.

3. Peptizer

The polyalkenamer rubber compositions used in the present invention also may incorporate one or more of the so-called “peptizers”.

The peptizer preferably comprises an organic sulfur compound and/or its metal or non-metal salt. Examples of such organic sulfur compounds include, without limitation, thiophenols, such as pentachlorothiophenol, 4-butyl-o-thiocresol, 4 t-butyl-p-thiocresol, and 2-benzamidothiophenol; thiocarboxylic acids, such as thiobenzoic acid; 4,4′ dithio dimorpholine; and, sulfides, such as dixylyl disulfide, dibenzoyl disulfide; dibenzothiazyl disulfide; di(pentachlorophenyl)disulfide; dibenzamido diphenyldisulfide (DBDD), and alkylated phenol sulfides, such as VULTAC marketed by Atofina Chemicals, Inc. of Philadelphia, Pa. Preferred organic sulfur compounds include pentachlorothiophenol, and dibenzamido diphenyldisulfide.

Examples of the metal salt of an organic sulfur compound include, without limitation, sodium, potassium, lithium, magnesium calcium, barium, cesium and zinc salts of the above-mentioned thiophenols and thiocarboxylic acids, with the zinc salt of pentachlorothiophenol being most preferred.

Examples of the non-metal salt of an organic sulfur compound include, without limitation, ammonium salts of the above-mentioned thiophenols and thiocarboxylic acids wherein the ammonium cation has the general formula [NR¹R²R³R⁴]⁺ where R¹, R², R³ and R⁴ are selected from the group consisting of hydrogen, a C₁-C₂₀ aliphatic, cycloaliphatic or aromatic moiety, and any and all combinations thereof, with the most preferred being the NH₄⁺-salt of pentachlorothiophenol.

The peptizer, if employed to manufacture golf balls of the present invention, is present in an amount of from about 0.01 parts to about 10 parts by weight, preferably of from about 0.10 parts to about 7 parts by weight, more preferably of from about 0.15 parts to about 5 parts by weight per 100 parts by weight of the polyalkenamer rubber component.

4. Accelerators

The polyalkenamer rubber composition also can comprise one or more accelerators of one or more classes. Accelerators are added to an unsaturated polymer to increase the vulcanization rate and/or decrease the vulcanization temperature. Accelerators can be of any class known for rubber processing including mercapto-, sulfenamide-, thiuram, dithiocarbamate, dithiocarbamyl-sulfenamide, xanthate, guanidine, amine, thiourea, and dithiophosphate accelerators. Specific commercial accelerators include 2-mercaptobenzothiazole and its metal or non-metal salts, such as Vulkacit Mercapto C, Mercapto MGC, Mercapto ZM-5, and ZM marketed by Bayer AG of Leverkusen, Germany, Nocceler M, Nocceler MZ, and Nocceler M-60 marketed by Ouchisinko Chemical Industrial Company, Ltd. of Tokyo, Japan, and MBT and ZMBT marketed by Akrochem Corporation of Akron, Ohio. A more complete list of commercially available accelerators is given in The Vanderbilt Rubber Handbook: 13^{th} Edition (1990, R.T. Vanderbilt Co.), pp. 296-330, in Encyclopedia of Polymer Science and Technology, Vol. 12 (1970, John Wiley & Sons), pp. 258-259, and in Rubber Technology Handbook (1980, Hanser/Gardner Publications), pp. 234-236. Preferred accelerators include 2-mercaptobenzothiazole (MBT) and its salts.

The polyalkenamer rubber composition can further incorporate from about 0.1 part to about 10 parts by weight of the accelerator per 100 parts by weight of the polyalkenamer rubber. More preferably, the ball composition can further incorporate from about 0.2 part to about 5 parts, and most preferably from about 0.5 part to about 1.5 parts, by weight of the accelerator per 100 parts by weight of the polyalkenamer rubber.

C. Synthetic and Natural Rubbers

Traditional rubber components used in golf ball applications can be used to make golf balls according to the present invention including, without limitation, both natural and synthetic rubbers, such as cis-1,4-polybutadienes, trans-1,4-polybutadienes, 1,2-polybutadienes, cis-polyisoprenes, trans-polyisoprenes, polychloroprenes, polybutylenes, styrene-butadiene rubbers, styrene-butadiene-styrene block copolymers and partially and fully hydrogenated equivalents, styrene-isoprene-styrene block copolymers and partially and fully hydrogenated equivalents, nitrile rubbers, silicone rubbers, and polyurethanes, as well as mixtures of these materials. Polybutadiene rubbers, especially 1,4-polybutadiene rubbers containing at least 40 mol %, and more preferably 80 to 100 mol % of cis-1,4 bonds, are preferred because of their high rebound resilience, moldability, and high strength after vulcanization. The polybutadiene component may be purchased, if commercially available, or synthesized by methods now known or hereafter developed, including using rare earth-based catalysts, nickel-based catalysts, or cobalt-based catalysts, that conventionally are used in this field. Polybutadiene obtained by using lanthanum rare earth-based catalysts usually employ a combination of a lanthanum rare earth (atomic number of 57 to 71) compound, but particularly preferred is a neodymium compound.

The 1,4-polybutadiene rubbers have a molecular weight distribution (Mw/Mn) of from about 1.2 to about 4.0, preferably from about 1.7 to about 3.7, even more preferably from about 2.0 to about 3.5, and most preferably from about 2.2 to about 3.2. The polybutadiene rubbers have a Mooney viscosity (ML₁₊₄ (100° C.)) of from about −10 to about 80, preferably from about 20 to about 70, even more preferably from about 30 to about 60, and most preferably from about 35 to about 50. “Mooney viscosity” refers to an industrial index of viscosity as measured with a Mooney viscometer, which is a type of rotary plastometer (see JIS K6300). This value is represented by the symbol ML₁₊₄ (100° C.), wherein “M” stands for Mooney viscosity, “L” stands for large rotor (L-type), “1+4” stands for a pre-heating time of 1 minute and a rotor rotation time of 4 minutes, and “100° C.” indicates that measurement was carried out at a temperature of 100° C.

Examples of 1,2-polybutadienes having differing tacticity, all of which are suitable as unsaturated polymers for use in the present invention, are atactic 1,2-polybutadienes, isotactic 1,2-polybutadienes, and syndiotactic 1,2-polybutadienes. Syndiotactic 1,2-polybutadienes having crystallinity suitable for use as an unsaturated polymer in compositions within the scope of the present invention are polymerized from a 1,2-addition of butadiene. Golf balls within the scope of the present invention include syndiotactic 1,2-polybutadienes having crystallinity and greater than about 70% of 1,2-bonds, more preferably greater than about 80% of 1,2-bonds, and most preferably greater than about 90% of 1,2-bonds. Also, golf balls within the scope of the present invention not only have such crystallinity but also have a mean molecular weight of between from about 10,000 to about 350,000, more preferably between from about 50,000 to about 300,000, more preferably between from about 80,000 to about 200,000, and most preferably between from about 10,000 to about 150,000. Examples of suitable syndiotactic 1,2-polybutadienes having crystallinity suitable for use in golf balls within the scope of the present invention are sold under the trade names RB810, RB820, and RB830 by JSR Corporation of Tokyo, Japan. These have more than 90% of 1,2 bonds, a mean molecular weight of approximately 120,000, and crystallinity between about 15% and about 30%.

D. Thermoplastic Materials

1. Olefinic Thermoplastic Elastomers

Examples of olefinic thermoplastic elastomers include, without limitation, metallocene-catalyzed polyolefins, ethylene-octene copolymers, ethylene-butene copolymers, and ethylene-propylene copolymers all with or without controlled tacticity as well as blends of polyolefins having ethyl-propylene-non-conjugated diene terpolymers, rubber-based copolymers, and dynamically vulcanized rubber-based copolymers. Examples of such polymers that are commercially available include products sold under the trade names SANTOPRENE, DYTRON, VISTAFLEX, and VYRAM by Advanced Elastomeric Systems of Houston, Tex., and SARLINK by DSM of Haarlen, the Netherlands.

2. Co-Polyester Thermoplastic Elastomers

Examples of copolyester thermoplastic elastomers include polyether ester block copolymers, polylactone ester block copolymers, and aliphatic and aromatic dicarboxylic acid copolymerized polyesters. Polyether ester block copolymers are copolymers comprising polyester hard segments polymerized from a dicarboxylic acid and a low molecular weight diol, and polyether soft segments polymerized from an alkylene glycol having 2 to 10 atoms. Polylactone ester block copolymers are copolymers having polylactone chains instead of polyether as the soft segments discussed above for polyether ester block copolymers. Aliphatic and aromatic dicarboxylic copolymerized polyesters are copolymers of an acid component selected from aromatic dicarboxylic acids, such as terephthalic acid and isophthalic acid, and aliphatic acids having 2 to 10 carbon atoms with at least one diol component, selected from aliphatic and alicyclic diols having 2 to 10 carbon atoms. Blends of aromatic polyester and aliphatic polyester also may be used for these. Examples of these include products marketed under the trade names HYTREL by E.I. DuPont de Nemours & Company, and SKYPEL by S.K. Chemicals of Seoul, South Korea.

3. Other Thermoplastic Elastomers

Examples of other thermoplastic elastomers include multiblock, rubber-based copolymers, particularly those in which the rubber block component is based on butadiene, isoprene, or ethylene/butylene. The non-rubber repeating units of the copolymer may be derived from any suitable monomer, including meth(acrylate) esters, such as methyl methacrylate and cyclohexylmethacrylate, and vinyl arylenes, such as styrene. Styrenic block copolymers are copolymers of styrene with butadiene, isoprene, or a mixture of the two. Additional unsaturated monomers may be added to the structure of the styrenic block copolymer as needed for property modification of the resulting SBC/urethane copolymer. The styrenic block copolymer can be a diblock or a triblock styrenic polymer. Examples of such styrenic block copolymers are described in, for example, U.S. Pat. No. 5,436,295 to Nishikawa et al., which is incorporated herein by reference. The styrenic block copolymer can have any known molecular weight for such polymers, and it can possess a linear, branched, star, dendrimeric or combination molecular structure. The styrenic block copolymer can be unmodified by functional groups, or it can be modified by hydroxyl group, carboxyl group, or other functional groups, either in its chain structure or at one or more terminus. The styrenic block copolymer can be obtained using any common process for manufacture of such polymers. The styrenic block copolymers also may be hydrogenated using well-known methods to obtain a partially or fully saturated diene monomer block. Examples of styrenic copolymers include, without limitation, resins manufactured by Kraton Polymers (formerly of Shell Chemicals) under the trade names KRATON D (for styrene-butadiene-styrene and styrene-isoprene-styrene types), and KRATON G (for styrene-ethylene-butylene-styrene and styrene-ethylene-propylene-styrene types) and Kuraray under the trade name SEPTON. Examples of randomly distributed styrenic polymers include paramethylstyrene-isobutylene (isobutene) copolymers developed by ExxonMobil Chemical Corporation and styrene-butadiene random copolymers developed by Chevron Phillips Chemical Corporation.

Examples of other thermoplastic elastomers suitable as additional polymer components in the present invention include those having functional groups, such as carboxylic acid, maleic anhydride, glycidyl, norbonene, and hydroxyl functionalities. An example of these includes a block polymer having at least one polymer block A comprising an aromatic vinyl compound and at least one polymer block B comprising a conjugated diene compound, and having a hydroxyl group at the terminal block copolymer, or its hydrogenated product. An example of this polymer is sold under the trade name SEPTON HG-252 by Kuraray Company of Kurashiki, Japan. Other examples of these include: maleic anhydride functionalized triblock copolymer consisting of polystyrene end blocks and poly(ethylene/butylene), sold under the trade name KRATON FG 1901X by Shell Chemical Company; maleic anhydride modified ethylene-vinyl acetate copolymer, sold under the trade name FUSABOND by E.I. DuPont de Nemours & Company; ethylene-isobutyl acrylate-methacrylic acid terpolymer, sold under the trade name NUCREL by E.I. DuPont de Nemours & Company; ethylene-ethyl acrylate-methacrylic anhydride terpolymer, sold under the trade name BONDINE AX 8390 and 8060 by Sumitomo Chemical Industries; brominated styrene-isobutylene copolymers sold under the trade name BROMO XP-50 by Exxon Mobil Corporation; and resins having glycidyl or maleic anhydride functional groups sold under the trade name LOTADER by Elf Atochem of Puteaux, France.

4. Polyamides

Examples of polyamides within the scope of the present invention include resins obtained by: (1) polycondensation of (a) a dicarboxylic acid, such as oxalic acid, adipic acid, sebacic acid, terephthalic acid, isophthalic acid, or 1,4-cyclohexanedicarboxylic acid, with (b) a diamine, such as ethylenediamine, tetramethylenediamine, pentamethylenediamine, hexamethylenediamine, decamethylenediamine, 1,4-cyclohexyldiamine or m-xylylenediamine; (2) a ring-opening polymerization of cyclic lactam, such as ε-caprolactam or ω-laurolactam; (3) polycondensation of an aminocarboxylic acid, such as 6-aminocaproic acid, 9-aminononanoic acid, 11-aminoundecanoic acid or 12-aminododecanoic acid; or (4) copolymerization of a cyclic lactam with a dicarboxylic acid and a diamine, and any combination of those Specific examples of suitable polyamides include polyamide 6; polyamide 11; polyamide 12; polyamide 4,6; polyamide 6,6; polyamide 6,9; polyamide 6,10; polyamide 6,12; PA12CX; PA12, IT; PPA; PA6, IT.

Non-limiting examples of suitable polyamides or copolymeric polyamides for use in the inner mantle and/or the outer mantle layer include those sold under the trademarks PEBAX, CRISTAMID and RILSAN marketed by ATOFINA Chemicals of Philadelphia, Pa.; GRILAMID marketed by EMS CHEMIE of Sumter, S.C.; TROGAMID marketed by Degussa of Dusseldorf, Germany; and ZYTEL marketed by E.I. DuPont de Nemours & Co. of Wilmington, Del.

5. Polyamide Elastomer

Examples of polyamide elastomers within the scope of the present invention include polyether amide elastomers, which result from the copolycondensation of polyamide blocks having reactive chain ends with polyether blocks having reactive chain ends, including: 1) polyamide blocks of diamine chain ends with polyoxyalkylene sequences of dicarboxylic chain ends; 2) polyamide blocks of dicarboxylic chain ends with polyoxyalkylene sequences of diamine chain ends obtained by cyanoethylation and hydrogenation of polyoxyalkylene alpha-omega dihydroxylated aliphatic sequences known as polyether diols; and 3) polyamide blocks of dicarboxylic chain ends with polyether diols, the products obtained, in this particular case, being polyetheresteramides.

The polyamide blocks of dicarboxylic chain ends come, for example, from the condensation of alpha-omega aminocarboxylic acids of lactam or of carboxylic diacids and diamines in the presence of a carboxylic diacid which limits the chain length. The molecular weight of the polyamide sequences preferably is between about 300 and about 15,000, and more preferably between about 600 and about 5,000. The molecular weight of the polyether sequences preferably is between about 100 and about 6,000, and more preferably between about 200 and about 3,000.

The amide block polyethers also may comprise randomly distributed units. These polymers may be prepared by the simultaneous reaction of polyether and precursor of polyamide blocks.

For example, the polyether diol may react with a lactam (or alpha-omega amino acid) and a diacid which limits the chain in the presence of water. A polymer is obtained having mainly polyether blocks, polyamide blocks of very variable length, but also the various reactive groups having reacted in a random manner and which are distributed statistically along the polymer chain.

Suitable amide block polyethers include, without limitation, those disclosed in U.S. Pat. Nos. 4,331,786, 4,115,475, 4,195,015, 4,839,441, 4,864,014, 4,230,838, and 4,332,920, which are incorporated herein in their entireties by reference. The polyether may be, for example, a polyethylene glycol (PEG), a polypropylene glycol (PPG), or a polytetramethylene glycol (PTMG), also designated as polytetrahydrofurane (PTHF).

The polyether blocks may be along the polymer chain in the form of diols or diamines. However, for reasons of simplification, they are designated PEG blocks, or PPG blocks, or also PTMG blocks.

It is also within the scope of the disclosed embodiments that the polyether block comprises different units such as units, which derive from ethylene glycol, propylene glycol, or tetramethylene glycol.

The amide block polyether comprises at least one type of polyamide block and one type of polyether block. Mixing two or more polymers with polyamide blocks and polyether blocks also may be used. It also can comprise any amide structure made from the method described on the above.

Preferably, the amide block polyether is such that it represents the major component in weight, i.e., that the amount of polyamide which is under the block configuration and that which is eventually distributed statistically in the chain represents 50 weight percent or more of the amide block polyether. Advantageously, the amount of polyamide and the amount of polyether is in a ratio (polyamide/polyether) of about 1:1 to about 3:1.

One type of polyetherester elastomer is the family of Pebax, which are available from Elf-Atochem Company. Preferably, the choice can be made from among Pebax 2533, 3533, 4033, 1205, 7033, and 7233. Blends or combinations of Pebax 2533, 3533, 4033, 1205, 7033, and 7233 also can be prepared, as well. Pebax 2533 has a hardness of about 25 shore D (according to ASTM D-2240), a Flexural Modulus of about 2.1 kpsi (according to ASTM D-790), and a Bayshore resilience of about 62% (according to ASTM D-2632). Pebax 3533 has a hardness of about 35 shore D (according to ASTM D-2240), a Flexural Modulus of about 2.8 kpsi (according to ASTM D-790), and a Bayshore resilience of about 59% (according to ASTM D-2632). Pebax 7033 has a hardness of about 69 shore D (according to ASTM D-2240) and a Flexural Modulus of about 67 kpsi (according to ASTM D-790). Pebax 7333 has a hardness of about 72 shore D (according to ASTM D-2240) and a Flexural Modulus of about 107 kpsi (according to ASTM D-790).

6. Polyurethanes

Another example of an additional polymer component includes polyurethanes, which are the reaction product of a diol or polyol and an isocyanate, with or without a chain extender. Polyurethanes are described in the patent literature, and some are known for use in making golf ball cores. See, for example, Vedula et al., U.S. Pat. No. 5,959,059.

Isocyanates used for making the urethanes of the present invention encompass diisocyanates and polyisocyanates. Examples of suitable isocyanates include the following: trimethylene diisocyanates, tetramethylene diisocyanates, pentamethylene diisocyanates, hexamethylene diisocyanates, ethylene diisocyanates, diethylidene diisocyanates, propylene diisocyanates, butylene diisocyanates, bitolylene diisocyanates, tolidine isocyanates, isophorone diisocyanates, dimeryl diisocyanates, dodecane-1,12-diisocyanates, 1,10-decamethylene diisocyanates, cyclohexylene-1,2-diisocyanates, 1-chlorobenzene-2,4-diisocyanates, furfurylidene diisocyanates, 2,4,4-trimethyl hexamethylene diisocyanates 2,2,4-trimethyl hexamethylene diisocyanates, dodecamethylene diisocyanates, 1,3-cyclopentane diisocyanates, 1,3-cyclohexane diisocyanates, 1,3-cyclobutane diisocyanates, 1,4-cyclohexane diisocyanates, 4,4′-methylenebis(cyclohexyl isocyanates), 4,4′-methylenebis(phenyl isocyanates), 1-methyl-2,4-cyclohexane diisocyanates, 1-methyl-2,6-cyclohexane diisocyanates, 1,3-bis(isocyanato-methyl)cyclohexanes, 1,6-diisocyanato-2,2,4,4-tetra-methylhexanes, 1,6-diisocyanato-2,4,4-tetra-trimethylhexanes, trans-cyclohexane-1,4-diisocyanates, 3-isocyanato-methyl-3,5,5-trimethylcyclohexyl isocyanates, 1-isocyanato-3,3,5-trimethyl-5-isocyanatomethylcyclohexanes, cyclohexyl isocyanates, dicyclohexylmethane 4,4′-diisocyanates, 1,4-bis(isocyanatomethyl)cyclohexanes, m-phenylene diisocyanate, m-xylylene diisocyanate, m-tetramethylxylylene diisocyanates, p-phenylene diisocyanate, p,p′-biphenyl diisocyanates, 3,3′-dimethyl-4,4′-biphenylene diisocyanates, 3,3′-dimethoxy-4,4′-biphenylene diisocyanates, 3,3′-diphenyl-4,4′-biphenylene diisocyanates, 4,4′-biphenylene diisocyanates, 3,3′-dichloro-4,4′-biphenylene diisocyanates, 1,5-naphthalene diisocyanates, 4-chloro-1,3-phenylene diisocyanates, 1,5-tetrahydronaphthalene diisocyanates, meta-xylene diisocyanates, 2,4-toluene diisocyanates, 2,4′-diphenylmethane diisocyanates, 2,4-chlorophenylene diisocyanates, 4,4′-diphenylmethane diisocyanates, p,p′-diphenylmethane diisocyanate, 2,4-tolylene diisocyanates, 2,6-tolylene diisocyanates, 2,2-diphenylpropane-4,4′-diisocyanate, 4,4′-toluidine diisocyanates, dianisidine diisocyanates, 4,4′-diphenyl ether diisocyanates, 1,3-xylylene diisocyanates, 1,4-naphthylene diisocyanates, azobenzene-4,4′-diisocyanates, diphenyl sulfone-4,4′-diisocyanates, triphenylmethane 4,4′,4″-triisocyanates, isocyanatoethyl methacrylates, 3-isopropenyl-α,α-dimethylbenzyl-isocyanates, dichlorohexamethylene diisocyanates, ω,ω′-diisocyanato-1,4-diethylbenzenes, polymethylene polyphenylene polyisocyanates, polybutylene diisocyanates, isocyanurate modified compounds, and carbodiimide modified compounds, as well as biuret modified compounds of the above polyisocyanates. Each isocyanate may be used either alone or in combination with one or more other isocyanates. These isocyanate mixtures can include triisocyanates, such as biuret of hexamethylene diisocyanate and triphenylmethane triisocyanate, and polyisocyanates, such as polymeric diphenylmethane diisocyanate.

Polyols used for making the polyurethane in the copolymer include polyester polyols, polyether polyols, polycarbonate polyols and polybutadiene polyols. Polyester polyols are prepared by condensation or step-growth polymerization utilizing diacids. Primary diacids for polyester polyols are adipic acid and isomeric phthalic acids. Adipic acid is used for materials requiring added flexibility, whereas phthalic anhydride is used for those requiring rigidity. Some examples of polyester polyols include poly(ethylene adipate) (PEA), poly(diethylene adipate) (PDA), poly(propylene adipate) (PPA), poly(tetramethylene adipate) (PBA), poly(hexamethylene adipate) (PHA), poly(neopentylene adipate) (PNA), polyols composed of 3-methyl-1,5-pentanediol and adipic acid, random copolymer of PEA and PDA, random copolymer of PEA and PPA, random copolymer of PEA and PBA, random copolymer of PHA and PNA, caprolactone polyol obtained by the ring-opening polymerization of ε-caprolactone, and polyol obtained by opening the ring of β-methyl-δ-valerolactone with ethylene glycol can be used either alone or in a combination thereof. Additionally, polyester polyols may be composed of a copolymer of at least one of the following acids and at least one of the following glycols. The acids include terephthalic acid, isophthalic acid, phthalic anhydride, oxalic acid, malonic acid, succinic acid, pentanedioic acid, hexanedioic acid, octanedioic acid, nonanedioic acid, adipic acid, azelaic acid, sebacic acid, dodecanedioic acid, dimer acid (a mixture), p-hydroxybenzoate, trimellitic anhydride, ε-caprolactone, and β-methyl-δ-valerolactone. The glycols includes ethylene glycol, propylene glycol, butylene glycol, pentylene glycol, 1,4-butanediol, 1,5-pentanediol, 1,6-hexanediol, neopentylene glycol, polyethylene glycol, polytetramethylene glycol, 1,4-cyclohexane dimethanol, pentaerythritol, and 3-methyl-1,5-pentanediol.

Polyether polyols are prepared by the ring-opening addition polymerization of an alkylene oxide (e.g. ethylene oxide and propylene oxide) with an initiator of a polyhydric alcohol (e.g. diethylene glycol), which has an active hydrogen. Specifically, polypropylene glycol (PPG), polyethylene glycol (PEG) or propylene oxide-ethylene oxide copolymer can be obtained. Polytetramethylene ether glycol (PTMG) is prepared by the ring-opening polymerization of tetrahydrofuran, produced by dehydration of 1,4-butanediol or hydrogenation of furan. Tetrahydrofuran can form a copolymer with alkylene oxide. Specifically, tetrahydrofuran-propylene oxide copolymer or tetrahydrofuran-ethylene oxide copolymer can be formed. A polyether polyol may be used either alone or in a mixture.

Polycarbonate polyols are obtained by the condensation of a known polyol (polyhydric alcohol) with phosgene, chloroformic acid ester, dialkyl carbonate or diallyl carbonate. A particularly preferred polycarbonate polyol contains a polyol component using 1,6-hexanediol, 1,4-butanediol, 1,3-butanediol, neopentylglycol or 1,5-pentanediol. A polycarbonate polyol can be used either alone or in a mixture.

Polybutadiene polyols include liquid diene polymer containing hydroxyl groups, and an average of at least 1.7 functional groups, and may be composed of diene polymers or diene copolymers having 4 to 12 carbon atoms, or a copolymer of such diene with addition to polymerizable α-olefin monomer having 2 to 2.2 carbon atoms. Specific examples include butadiene homopolymer, isoprene homopolymer, butadiene-styrene copolymer, butadiene-isoprene copolymer, butadiene-acrylonitrile copolymer, butadiene-2-ethyl hexyl acrylate copolymer, and butadiene-n-octadecyl acrylate copolymer. These liquid diene polymers can be obtained, for example, by heating a conjugated diene monomer in the presence of hydrogen peroxide in a liquid reactant. A polybutadiene polyol can be used either alone or in a mixture.

Urethanes used to practice the present invention also may incorporate chain extenders. Non-limiting examples of these extenders include polyols, polyamine compounds, and mixtures of these. Polyol extenders may be primary, secondary, or tertiary polyols. Specific examples of monomers of these polyols include: trimethylolpropane (TMP), ethylene glycol, 1,3-propanediol, 1,4-butanediol, 1,5-pentanediol, 1,6-hexanediol, propylene glycol, dipropylene glycol, 1,2-butanediol, 1,3-butanediol, 2,3-butanediol, 1,2-pentanediol, 2,3-pentanediol, 2,5-hexanediol, 2,4-hexanediol, 2-ethyl-1,3-hexanediol, cyclohexanediol, and 2-ethyl-2-(hydroxymethyl)-1,3-propanediol.

Suitable polyamines that may be used as chain extenders include primary, secondary and tertiary amines. Polyamines have two or more amine functional groups. Examples of polyamines include, without limitation: aliphatic diamines, such as tetramethylenediamine, pentamethylenediamine, hexamethylenediamine; alicyclic diamines, such as 3,3′-dimethyl-4,4′-diamino-dicyclohexyl methane; or aromatic diamines, such as 4,4′-methylene bis-2-chloroaniline, dimethylthio-2,4-toluene diamine, diethyl-2,4-toluene diamine, 2,2′,3,3′-tetrachloro-4,4′-diaminophenyl methane, p,p′-methylenedianiline, p-phenylenediamine or 4,4′-diaminodiphenyl; and 2,4,6-tris(dimethylaminomethyl)phenol, and any and all combinations thereof. A chain extender may be used either alone or in a mixture.

7. Ethylenically Unsaturated Thermoplastic Elastomers

Another family of thermoplastic elastomers for use in the golf balls of the present invention are polymers of (i) ethylene and/or an alpha olefin; and (ii) an α,β-ethylenically unsaturated C₃-C₂₀ carboxylic acid or anhydride, or an α,β-ethylenically unsaturated C₃-C₂₀ sulfonic acid or anhydride or an α,β-ethylenically unsaturated C₃-C₂₀ phosphoric acid or anhydride and, optionally iii) a C₁-C₁₀ ester of an α,β-ethylenically unsaturated C₃-C₂₀ carboxylic acid or a C₁-C₁₀ ester of an α,β-ethylenically unsaturated C₃-C₂₀ sulfonic acid or a C₁-C₁₀ ester of an α,β-ethylenically unsaturated C₃-C₂₀ phosphoric acid.

Preferably, the alpha-olefin has from 2 to 10 carbon atoms and is preferably ethylene, and the unsaturated carboxylic acid is a carboxylic acid having from about 3 to 8 carbons. Examples of such acids include acrylic acid, methacrylic acid, ethacrylic acid, chloroacrylic acid, crotonic acid, maleic acid, fumaric acid, and itaconic acid, with acrylic acid and methacrylic acid being preferred. Preferably, the carboxylic acid ester of if present may be selected from the group consisting of vinyl esters of aliphatic carboxylic acids wherein the acids have 2 to 10 carbon atoms and vinyl ethers wherein the alkyl groups contain 1 to 10 carbon atoms.

Examples of such polymers suitable for use include, but are not limited to, an ethylene/acrylic acid copolymer, an ethylene/methacrylic acid copolymer, an ethylene/itaconic acid copolymer, an ethylene/maleic acid copolymer, an ethylene/methacrylic acid/vinyl acetate copolymer, an ethylene/acrylic acid/vinyl alcohol copolymer, and the like.

Most preferred are ethylene/(meth)acrylic acid copolymers and ethylene/(meth)acrylic acid/alkyl(meth)acrylate terpolymers, or ethylene and/or propylene maleic anhydride copolymers and terpolymers.

The acid content of the polymer may contain anywhere from 1 to 30 percent by weight acid. In some instances, it is preferable to utilize a high acid copolymer (i.e., a copolymer containing greater than 16% by weight acid, preferably from about 17 to about 25 weight percent acid, and more preferably about 20 weight percent acid).

Examples of such polymers which are commercially available include, but are not limited to, the Escor® 5000, 5001, 5020, 5050, 5070, 5100, 5110 and 5200 series of ethylene-acrylic acid copolymers sold by Exxon and the PRIMACOR® 1321, 1410, 1410-XT, 1420, 1430, 2912, 3150, 3330, 3340, 3440, 3460, 4311 and 4608 series of ethylene-acrylic acid copolymers sold by The Dow Chemical Company, Midland, Mich.

Also included are the bimodal ethylene/carboxylic acid polymers as described in U.S. Pat. No. 6,562,906, the entire contents of which are herein incorporated by reference. These polymers comprise ethylene/α,β-ethylenically unsaturated C₃₋₈ carboxylic acid high copolymers, particularly ethylene (meth)acrylic acid copolymers and ethylene, alkyl (meth)acrylate, (meth)acrylic acid terpolymers, having molecular weights of about 80,000 to about 500,000 which are melt blended with ethylene/α,β-ethylenically unsaturated C₃₋₈ carboxylic acid copolymers, particularly ethylene/(meth)acrylic acid copolymers having molecular weights of about 2,000 to about 30,000.

8. Ionomers

The core, cover layer and, optionally, one or more inner cover layers golf ball embodiments of the present invention may further comprise one or more ionomer resins. One family of such resins was developed in the mid-1960's, by E.I. DuPont de Nemours and Co., and sold under the trademark SURLYN®. Preparation of such ionomers is well known, for example see U.S. Pat. No. 3,264,272 (the entire contents of which are herein incorporated by reference). Generally speaking, most commercial ionomers are unimodal and consist of a polymer of a mono-olefin, e.g., an alkene, with an unsaturated mono- or dicarboxylic acids having 3 to 12 carbon atoms. An additional monomer in the form of a mono- or dicarboxylic acid ester also may be incorporated in the formulation as a so-called “softening comonomer”. The incorporated carboxylic acid groups are then neutralized by a basic metal ion salt, to form the ionomer. The metal cations of the basic metal ion salt used for neutralization include Li⁺, Na⁺, K⁺, Zn²⁺, Ca²⁺, Co^{2+, Ni}²⁺, Cu²⁺, Pb²⁺, and Mg²⁺, with the Li⁺, Na⁺, Ca²⁺, Zn²⁺, and Mg²⁺ being preferred. The basic metal ion salts include those of, for example, formic acid, acetic acid, nitric acid, and carbonic acid, hydrogen carbonate salts, oxides, hydroxides, and alkoxides.

The first commercially available ionomer resins contained up to 16 weight percent acrylic or methacrylic acid, although it also was well known at that time that, as a general rule, the hardness of these cover materials could be increased with increasing acid content. Hence, in Research Disclosure 29703, published in January 1989, DuPont disclosed ionomers based on ethylene/acrylic acid or ethylene/methacrylic acid containing acid contents of greater than 15 weight percent. In this same disclosure, DuPont also taught that such so called “high acid ionomers” had significantly improved stiffness and hardness and thus could be advantageously used in golf ball construction, when used either singly or in a blend with other ionomers.

More recently, high acid ionomers are typically defined as those ionomer resins with acrylic or methacrylic acid units present from 16 weight percent to about 35 weight percent in the polymer. Generally, such a high acid ionomer will have a flexural modulus from about 50,000 psi to about 125,000 psi.

Ionomer resins may further comprise a softening comonomer, present from about 10 weight percent to about 50 weight percent in the polymer, have a flexural modulus from about 2,000 psi to about 10,000 psi, and are sometimes referred to as “soft” or “very low modulus” ionomers. Typical softening comonomers include n-butyl acrylate, iso-butyl acrylate, n-butyl methacrylate, methyl acrylate and methyl methacrylate.

Today, there are a wide variety of commercially available ionomer resins based both on copolymers of ethylene and (meth)acrylic acid or terpolymers of ethylene and (meth)acrylic acid and (meth)acrylate, many of which can be used as a golf ball component. The properties of these ionomer resins can vary widely due to variations in acid content, softening comonomer content, the degree of neutralization, and the type of metal ion used in the neutralization. The full range commercially available typically includes ionomers of polymers of general formula, E/X/Y, wherein E is ethylene, X is a C₃ to C₈ α,β-ethylenically unsaturated carboxylic acid, such as acrylic or methacrylic acid, and is present in an amount from about 2 to about 30 weight percent of the E/X/Y copolymer, and Y is a softening comonomer selected from the group consisting of alkyl acrylate and alkyl methacrylate, such as methyl acrylate or methyl methacrylate, and wherein the alkyl groups have from 1-8 carbon atoms, Y is in the range of 0 to about 50 weight percent of the E/X/Y copolymer, and wherein the acid moiety is neutralized from about 1% to about 90% to form an ionomer with a cation such as lithium, sodium, potassium, magnesium, calcium, barium, lead, tin, zinc or aluminum, or a combination of such cations.

The ionomer also may be a so-called bimodal ionomer as described in U.S. Pat. No. 6,562,906 (the entire contents of which are herein incorporated by reference). These ionomers are bimodal as they are prepared from blends comprising polymers of different molecular weights. Specifically they include bimodal polymer blend compositions comprising:

a high molecular weight component having molecular weight of about 80,000 to about 500,000 and comprising one or more ethylene/α,β-ethylenically unsaturated C₃₋₈ carboxylic acid copolymers and/or one or more ethylene, alkyl(meth)acrylate, (meth)acrylic acid terpolymers; the high molecular weight component being partially neutralized with metal ions selected from the group consisting of lithium, sodium, potassium, zinc, calcium, magnesium, and a mixture of any these; and

a low molecular weight component having a molecular weight of from about 2,000 to about 30,000 and comprising one or more ethylene/α,β-ethylenically unsaturated C₃₋₈ carboxylic acid copolymers and/or one or more ethylene, alkyl(meth)acrylate, (meth)acrylic acid terpolymers; the low molecular weight component being partially neutralized with metal ions selected from the group consisting of lithium, sodium, potassium, zinc, calcium, magnesium, and a mixture of any these.

In addition to the unimodal and bimodal ionomers, also included are the so-called “modified ionomers” examples of which are described in U.S. Pat. Nos. 6,100,321, 6,329,458 and 6,616,552 and U.S. Patent Publication U.S. 2003/0158312 A1, the entire contents of all of which are herein incorporated by reference.

The modified unimodal ionomers are prepared by mixing:

an ionomeric polymer comprising ethylene, from 5 to 25 weight percent (meth)acrylic acid, and from 0 to 40 weight percent of a (meth)acrylate monomer, the ionomeric polymer neutralized with metal ions selected from the group consisting of lithium, sodium, potassium, zinc, calcium, magnesium, and a mixture of any these, and

from about 5 to about 40 weight percent (based on the total weight of said modified ionomeric polymer) of one or more fatty acids or metal salts of said fatty acid, the metal selected from the group consisting of calcium, sodium, zinc, potassium, and lithium, barium and magnesium and the fatty acid preferably being stearic acid.

The modified bimodal ionomers, which are ionomers derived from the earlier described bimodal ethylene/carboxylic acid polymers (as described in U.S. Pat. No. 6,562,906, the entire contents of which are herein incorporated by reference), are prepared by mixing:

a. a high molecular weight component having molecular weight of about 80,000 to about 500,000 and comprising one or more ethylene/α,β-ethylenically unsaturated C₃₋₈ carboxylic acid copolymers and/or one or more ethylene, alkyl(meth)acrylate, (meth)acrylic acid terpolymers; the high molecular weight component being partially neutralized with metal ions selected from the group consisting of lithium, sodium, zinc, calcium, potassium, magnesium, and a mixture of any of these;

b. a low molecular weight component having a molecular weight of about from about 2,000 to about 30,000 and comprising one or more ethylene/α,β-ethylenically unsaturated C₃₋₈ carboxylic acid copolymers and/or one or more ethylene, alkyl(meth)acrylate, (meth)acrylic acid terpolymers; the low molecular weight component being partially neutralized with metal ions selected from the group consisting of lithium, sodium, zinc, calcium, potassium, magnesium, and a mixture of any of these; and

c. from about 5 to about 40 weight percent (based on the total weight of said modified ionomeric polymer) of one or more fatty acids or metal salts of the fatty acid, the metal selected from the group consisting of calcium, sodium, zinc, potassium and lithium, barium and magnesium and the fatty acid preferably being stearic acid.

The fatty or waxy acid salts utilized in the various modified ionomers are composed of a chain of alkyl groups containing from about 4 to 75 carbon atoms (usually even numbered) and characterized by a —COOH terminal group. The generic formula for all fatty and waxy acids above acetic acid is CH₃ (CH₂)_{X}COOH, wherein the carbon atom count includes the carboxyl group. The fatty or waxy acids utilized to produce the fatty or waxy acid salts modifiers may be saturated or unsaturated, and they may be present in solid, semi-solid or liquid form.

Examples of suitable saturated fatty acids, i.e., fatty acids in which the carbon atoms of the alkyl chain are connected by single bonds, include but are not limited to, stearic acid (C₁₈, i.e., CH₃(CH₂)₁₆COOH), palmitic acid (C₁₆, i.e., CH₃(CH₂)₁₄COOH), pelargonic acid (C₉, i.e., CH₃(CH₂)₇COOH) and lauric acid (C₁₂, i.e., CH₃(CH₂)₁₀OCOOH). Examples of suitable unsaturated fatty acids, i.e., a fatty acid in which there are one or more double bonds between the carbon atoms in the alkyl chain, include but are not limited to oleic acid (C₁₈, i.e., CH₃(CH₂)₇CH:CH(CH₂)₇COOH).

The source of the metal ions used to produce the metal salts of the fatty or waxy acid salts used in the various modified ionomers are generally various metal salts, which provide the metal ions capable of neutralizing, to various extents, the carboxylic acid groups of the fatty acids. These include the sulfate, carbonate, acetate and hydroxylate salts of zinc, sodium, lithium, potassium, barium, calcium and magnesium.

Since the fatty acid salts modifiers comprise various combinations of fatty acids neutralized with a large number of different metal ions, several different types of fatty acid salts may be utilized in the invention, including metal stearates, laureates, oleates, and palmitates, with calcium, zinc, sodium, lithium, potassium and magnesium stearate being preferred, and calcium and sodium stearate being most preferred.

The fatty or waxy acid or metal salt of the fatty or waxy acid is present in the modified ionomeric polymers in an amount of from about 5 to about 40, preferably from about 7 to about 35, more preferably from about 8 to about 20 weight percent (based on the total weight of said modified ionomeric polymer).

As a result of the addition of the one or more metal salts of a fatty or waxy acid, from about 40 to 100, preferably from about 50 to 100, more preferably from about 70 to 100 percent of the acidic groups in the final modified ionomeric polymer composition are neutralized by a metal ion.

An example of such a modified ionomer polymer is DuPont® HPF-1000 available from E. I. DuPont de Nemours and Co. Inc.

### IV. Aliphatic, Alicyclic and/or Aromatic Amide Polymer Modifiers

Compositions of the present invention comprise a monomeric amide modifier or modifiers, such as a monomeric aliphatic, alicyclic and/or aromatic amide polymer modifier or modifiers. An amide is any organic compound containing the group —CONR₂, where R is hydrogen; an aliphatic group, such as an alkyl group, an alkenyl group, or an alkynyl group; an aromatic group; and combinations thereof. Amides useful for the present invention may be a primary amide, a secondary amide, or a tertiary amide, and combinations thereof, i.e. a particular compound may have two or more amide moieties where one of the amide moieties is a primary, secondary or tertiary amide and the other amide moiety has a degree of substitution different from the first amide moiety. For example, if the first amide is a primary amide, the second amide moiety may be secondary or tertiary.

The amide may be saturated or unsaturated. Moreover, unsaturated amides may have more than one site of unsaturation, including aromatic amides. Alkene amides may have a cis double bond or a trans double bond. For compounds having plural sites of unsaturation, such double bonds can be all cis, all trans, or any combination of cis and trans double bonds. Certain compounds perform better as polymer modifier if the olefin is entirely or predominantly cis, or entirely or predominantly trans. Moreover, the position of the double bond in the compound may affect the compound's usefulness for modifying polymer compositions.

Amidated aliphatic, alicyclic and/or aromatic compounds useful for the present invention typically have from about 1 to about 100 carbon atoms, more typically from about 2 to about 80 carbon atoms, even more typically from about 5 to about 50 carbon atoms, even more typically from about 5 to about 30 carbon atoms, and most typically from about 10 to about 25 carbon atoms.

Fatty acid amides are a particularly useful genus of amides for use with the present invention. Fatty acids are any of a class of aliphatic monocarboxylic acids that form part of a lipid molecule and can be derived from fat by hydrolysis; fatty acids are simple molecules built around a series of carbon atoms linked together in a chain, typically a chain having from about 12 to 22 carbon atoms.

Particular examples of amides for use with the present invention include, without limitation, primary amides, such as stearamide, behenamide, oleamide, and erucamide; secondary amides, such as stearyl erucamide, erucyl erucamide, oleyl palimitamide, stearyl stearamide, erucyl stearamide, and the like; ethylene bis-amides, such as N,N′ethylenebisstearamide, N,N′ethylenebisolamide, and the like; amidated natural waxes, such as carnauba wax amide, rice wax amide, montan wax amide, and the like; and combinations of any two or more of any suitable amide.

Suitable amide polymer composition modifiers can include a functional group or groups other than the amide functionality. For example and without limitation, amide polymer modifiers also can include additional functional groups such as hydroxyl, sulfhydryl, halides, glycidyl, carbonyl, carboxyl, anhydryl, ether, epoxide, amine, etc., and combinations of all such functional groups.

The polymer compositions of the present invention include amounts of the amide modifying agent effective to modify the compositions as desired. For example, amide modifiers can be used to provide more desirable rheological properties relative to non-modified polymeric compositions, more desirable mechanical properties relative to non-modified polymeric compositions, and combinations of rheological and mechanical properties. By way of example, it was surprising to find that useful polymeric compositions modified with a suitable monomeric amide, or amides, could be made such that the rheological properties, for example the melt flow index (MFI), could be advantageously modified. At the same time, mechanical properties, such as hardness and flexural modulus could be advantageously modified while COR could be substantially maintained, and for some formulations improved, relative to the same composition without the monomeric amide, or amides. It was particularly surprising that useful amounts of modifying agents could be increased to relatively high concentrations, such as 0.5% by weight or greater, to modify certain polymer properties advantageously while maintaining suitable COR values.

By way of example and without limitation, it currently is believed that amide modifiers can be added in amounts ranging from about 0.1 to about 50 parts per hundred (pph), more typically from about 0.1 to about 20 pph, more typically from about 0.5 pph to about 15 pph, and most typically from about 1 to about 10 pph, based on the weight of the polymeric portion of the composition.

### V. Fillers

The polymeric compositions used to prepare the golf balls of the present invention also can incorporate one or more fillers. Such fillers are typically in a finely divided form, for example, in a size generally less than about 20 mesh, preferably less than about 100 mesh U.S. standard size, except for fibers and flock, which are generally elongated. Filler particle size will depend upon desired effect, cost, ease of addition, and dusting considerations. The appropriate amounts of filler required will vary depending on the application but typically can be readily determined without undue experimentation.

The filler preferably is selected from the group consisting of precipitated hydrated silica, limestone, clay, talc, asbestos, barytes, glass fibers, aramid fibers, mica, calcium metasilicate, barium sulfate, zinc sulfide, lithopone, silicates, silicon carbide, diatomaceous earth, carbonates such as calcium or magnesium or barium carbonate, sulfates such as calcium or magnesium or barium sulfate, metals, including tungsten, steel, copper, cobalt or iron, metal alloys, tungsten carbide, metal oxides, metal stearates, and other particulate carbonaceous materials, and any and all combinations thereof. Preferred examples of fillers include metal oxides, such as zinc oxide and magnesium oxide. In another preferred embodiment the filler comprises a continuous or non-continuous fiber. In another preferred embodiment the filler comprises one or more so called nanofillers, as described in U.S. Pat. No. 6,794,447 and copending U.S. patent application Ser. No. 10/670,090 filed on Sep. 24, 2003 and copending U.S. patent application Ser. No. 10/926,509 filed on Aug. 25, 2004, the entire contents of each of which are incorporated herein by reference.

Inorganic nanofiller material generally is made of clay, such as hydrotalcite, phyllosilicate, saponite, hectorite, beidellite, stevensite, vermiculite, halloysite, mica, montmorillonite, micafluoride, or octosilicate. To facilitate incorporation of the nanofiller material into a polymer material, either in preparing nanocomposite materials or in preparing polymer-based golf ball compositions, the clay particles generally are coated or treated by a suitable compatibilizing agent. The compatibilizing agent allows for superior linkage between the inorganic and organic material, and it also can account for the hydrophilic nature of the inorganic nanofiller material and the possibly hydrophobic nature of the polymer. Compatibilizing agents may exhibit a variety of different structures depending upon the nature of both the inorganic nanofiller material and the target matrix polymer. Non-limiting examples include hydroxy-, thiol-, amino-, epoxy-, carboxylic acid-, ester-, amide-, and siloxy-group containing compounds, oligomers or polymers. The nanofiller materials can be incorporated into the polymer either by dispersion into the particular monomer or oligomer prior to polymerization, or by melt compounding of the particles into the matrix polymer: Examples of commercial nanofillers are various Cloisite grades including 10A, 15A, 20A, 25A, 30B, and NA+ of Southern Clay Products (Gonzales, Tex.) and the Nanomer grades including 1.24TL and C.30EVA of Nanocor, Inc. (Arlington Heights, Ill.).

As mentioned above, the nanofiller particles have an aggregate structure with the aggregates particle sizes in the micron range and above. However, these aggregates have a stacked plate structure with the individual platelets being roughly from about 1 nanometer (nm) thick and from about 100 to about 1000 nm across. As a result, nanofillers have extremely high surface area, resulting in high reinforcement efficiency to the material at low loading levels of the particles. The sub-micron-sized particles enhance the stiffness of the material, without increasing its weight or opacity and without reducing the material's low-temperature toughness.

Nanofillers when added into a matrix polymer, such as the polyalkenamer rubber, can be mixed in three ways. In one type of mixing there is dispersion of the aggregate structures within the matrix polymer, but on mixing no interaction of the matrix polymer with the aggregate platelet structure occurs, and thus the stacked platelet structure is essentially maintained. As used herein, this type of mixing is defined as “undispersed”.

However, if the nanofiller material is selected correctly, the matrix polymer chains can penetrate into the aggregates and separate the platelets, and thus when viewed by transmission electron microscopy or x-ray diffraction, the aggregates of platelets are expanded. At this point the nanofiller is said to be substantially evenly dispersed within and reacted into the structure of the matrix polymer. T his level of expansion can occur to differing degrees. If small amounts of the matrix polymer are layered between the individual platelets then, as used herein, this type of mixing is known as “intercalation”

In some circumstances, further penetration of the matrix polymer chains into the aggregate structure separates the platelets, and leads to a complete disruption of the platelet's stacked structure in the aggregate. Thus, when viewed by transmission electron microscopy (TEM), the individual platelets are thoroughly mixed throughout the matrix polymer. As used herein, this type of mixing is known as “exfoliated”. An exfoliated nanofiller has the platelets fully dispersed throughout the polymer matrix; the platelets may be dispersed unevenly but preferably are dispersed evenly.

While not wishing to be limited to any theory, one possible explanation of the differing degrees of dispersion of such nanofillers within the matrix polymer structure is the effect of the compatibilizer surface coating on the interaction between the nanofiller platelet structure and the matrix polymer. By careful selection of the nanofiller it is possible to vary the penetration of the matrix polymer into the platelet structure of the nanofiller on mixing. Thus, the degree of interaction and intrusion of the polymer matrix into the nanofiller controls the separation and dispersion of the individual platelets of the nanofiller within the polymer matrix. This interaction of the polymer matrix and the platelet structure of the nanofiller is defined herein as the nanofiller “reacting into the structure of the polymer” and the subsequent dispersion of the platelets within the polymer matrix is defined herein as the nanofiller “being substantially evenly dispersed” within the structure of the polymer matrix.

If no compatibilizer is present on the surface of a filler such as a clay, or if the coating of the clay is attempted after its addition to the polymer matrix, then the penetration of the matrix polymer into the nanofiller is much less efficient, very little separation and no dispersion of the individual clay platelets occurs within the matrix polymer.

Physical properties of the polymer will change with the addition of nanofiller. The physical properties of the polymer are expected to improve even more as the nanofiller is dispersed into the polymer matrix to form a nanocomposite.

Materials incorporating nanofiller materials can provide these property improvements at much lower densities than those incorporating conventional fillers. For example, a nylon-6 nanocomposite material manufactured by RTP Corporation of Wichita, Kans., uses a 3% to 5% clay loading and has a tensile strength of 11,800 psi and a specific gravity of 1.14, while a conventional 30% mineral-filled material has a tensile strength of 8,000 psi and a specific gravity of 1.36. Using nanocomposite materials with lower inorganic materials loadings than conventional fillers provides the same properties, and this allows products comprising nanocomposite fillers to be lighter than those with conventional fillers, while maintaining those same properties.

Nanocomposite materials are materials incorporating from about 0.1% to about 20%, preferably from about 0.1% to about 15%, and most preferably from about 0.1% to about 10% of nanofiller reacted into and substantially dispersed through intercalation or exfoliation into the structure of an organic material, such as a polymer, to provide strength, temperature resistance, and other property improvements to the resulting composite. Descriptions of particular nanocomposite materials and their manufacture can be found in U.S. Pat. No. 5,962,553 to Ellsworth, U.S. Pat. No. 5,385,776 to Maxfield et al., and U.S. Pat. No. 4,894,411 to Okada et al. Examples of nanocomposite materials currently marketed include M1030D, manufactured by Unitika Limited, of Osaka, Japan, and 1015C2, manufactured by UBE America of New York, N.Y.

When nanocomposites are blended with other polymer systems, the nanocomposite may be considered a type of nanofiller concentrate. However, a nanofiller concentrate may be more generally a polymer into which nanofiller is mixed; a nanofiller concentrate does not require that the nanofiller has reacted and/or dispersed evenly into the carrier polymer.

For the polyalkenamers, the nanofiller material is added in an amount of from about 0.1% to about 20%, preferably from about 0.1% to about 15%, and most preferably from about 0.1% to about 10% by weight of nanofiller reacted into and substantially dispersed through intercalation or exfoliation into the structure of the polyalkenamer.

If desired, the various polymer compositions used to prepare the golf balls of the present invention can additionally contain other conventional additives such as plasticizers, pigments, antioxidants, U.V. absorbers, optical brighteners, or any other additives generally employed in plastics formulation or the preparation of golf balls.

Another particularly well-suited additive for use in the compositions of the present invention includes compounds having the general formula:
(R₂N)ₘ—R′—(X(O)ₙOR_{y})ₘ,
where R is hydrogen, or a C₁-C₂₀ aliphatic, cycloaliphatic or aromatic systems; R′ is a bridging group comprising one or more C₁-C₂₀ straight chain or branched aliphatic or alicyclic groups, or substituted straight chain or branched aliphatic or alicyclic groups, or aromatic group, or an oligomer of up to 12 repeating units including, but not limited to, polypeptides derived from an amino acid sequence of up to 12 amino acids; and X is C or S or P with the proviso that when X=C, n=1 and y=1 and when X=S, n=2 and y=1, and when X=P, n=2 and y=2. Also, m=1-3. These materials are more fully described in copending U.S. patent application Ser. No. 11/182,170, filed on Jul. 14, 2005, the entire contents of which are incorporated herein by reference. These materials include, without limitation, caprolactam, oenantholactam, decanolactam, undecanolactam, dodecanolactam, caproic 6-amino acid, 11-aminoundecanoic acid, 12-aminododecanoic acid, diamine hexamethylene salts of adipic acid, azeleic acid, sebacic acid and 1,12-dodecanoic acid and the diamine nonamethylene salt of adipic acid, 2-aminocinnamic acid, L-aspartic acid, 5-aminosalicylic acid, aminobutyric acid; aminocaproic acid; aminocapyryic acid; 1-(aminocarbonyl)-1-cyclopropanecarboxylic acid; aminocephalosporanic acid; aminobenzoic acid; aminochlorobenzoic acid; 2-(3-amino-4-chlorobenzoyl)benzoic acid; aminonaphtoic acid; aminonicotinic acid; aminonorbornanecarboxylic acid; aminoorotic acid; aminopenicillanic acid; aminopentenoic acid; (aminophenyl)butyric acid; aminophenyl propionic acid; aminophthalic acid; aminofolic acid; aminopyrazine carboxylic acid; aminopyrazole carboxylic acid; aminosalicylic acid; aminoterephthalic acid; aminovaleric acid; ammonium hydrogencitrate; anthranillic acid; aminobenzophenone carboxylic acid; aminosuccinamic acid, epsilon-caprolactam; omega-caprolactam, (carbamoylphenoxy)acetic acid, sodium salt; carbobenzyloxy aspartic acid; carbobenzyl glutamine; carbobenzyloxyglycine; 2-aminoethyl hydrogensulfate; aminonaphthalenesulfonic acid; aminotoluene sulfonic acid; 4,4′-methylene-bis-(cyclohexylamine)carbamate and ammonium carbamate.

Most preferably the material is selected from the group consisting of 4,4′-methylene-bis-(cyclohexylamine)carbamate (commercially available from R.T. Vanderbilt Co., Norwalk Conn. under the tradename Diak® 4), 11-aminoundecanoic acid, 12-aminododecanoic acid, epsilon-caprolactam; omega-caprolactam, and any and all combinations thereof.

In an especially preferred embodiment a nanofiller additive component in the golf ball of the present invention is surface modified with a compatibilizing agent comprising the earlier described compounds having the general formula:
(R₂N)ₘ—R′(X(O)ₙOR_{y})ₘ,
A most preferred embodiment would be a filler comprising a nanofiller clay material surface modified with an amino acid including 12-aminododecanoic acid. Such fillers are available from Nanonocor Co. under the tradename Nanomer 1.24TL.

Golf ball components may, in addition to the materials specifically described herein, include other materials, such as UV stabilizers, photostabilizers, photoinitiators, co-initiators, antioxidants, colorants, dispersants, mold release agents, processing aids, inorganic fillers, organic fillers, and combinations of such materials.

### VI. Method for Making Disclosed Embodiments

The polymer/monomeric amide modifier compositions can be formed by any suitable mixing methods. The composition can be prepared by any suitable process, such as single screw extrusion, twin-screw extrusion, banbury mixing, two-roll mill mixing, dry blending, by using a master batch, or any combination of these techniques. The resulting compositions can be processed by any method useful to form golf balls or golf ball preforms, such as extrusion (or disclosed in detail in applicants' co-pending U.S. Application No. 60/699,303, incorporated herein by reference) profile-extrusion, pultrusion, compression molding, transfer molding, injection molding, cold-runner molding, hot-runner molding, reaction injection molding or any combination thereof. The polymer/polymer modifier composition can be a blend that is not subjected to any further crosslinking or curing; a blend that is subjected to crosslinking or curing; a blend that forms a semi- or full-interpenetrating polymer network (IPN) upon crosslinking or curing; or a thermoplastic vulcanizate blend. The composition can be crosslinked by any crosslinking method(s), such as, for example, using chemical crosslinking agents, applying thermal energy, irradiation, or a combination thereof. The crosslinking reaction can be performed during any processing stage, such as extrusion, compression molding, transfer molding, injection molding, post-curing, or a combination thereof. In one embodiment, the ability of the polymer/monomeric amide modifier compositions to be injection molded and cured either subsequently by compression molding or actually during the injection molding process itself provides considerable flexibility in manufacture of the individual golf ball components.

For instance, the polymer/monomeric amide modifier compositions including crosslinking agents, fillers and the like can be mixed together with or without melting individual components. Dry blending equipment, such as a tumble mixer, V-blender, ribbon blender, or two-roll mill, can be used to mix the compositions. The golf ball compositions can also be mixed using a mill, internal mixer such as a Banbury or Farrel continuous mixer, extruder or combinations of these, with or without application of thermal energy to produce melting. The various components can be mixed together with the cross-linking agents, or each additive can be added in an appropriate sequence. In another method of manufacture the cross-linking agents and other components can be added as part of a concentrate.

The resulting mixture can be subjected to, for example, a compression or injection molding process, to obtain solid spheres for the core. The polymer mixture is subjected to a molding cycle in which heat and pressure are applied while the mixture is confined within a mold. The cavity shape depends on the portion of the golf ball being formed.

Where crosslinking agents are used, the compression and heat may liberate free radicals, such as by decomposing one or more peroxides, which initiate cross-linking. The temperature and duration of the molding cycle are selected based upon the type of crosslinking agent selected. The molding cycle may have a single molding step that is performed at a particularly suitable temperature for fixed time duration; the molding cycle may have plural molding steps at plural different suitable temperatures for fixed durations; the molding cycle may include one or more steps where the temperature is increased or decreased from an initial temperature during the molding step period; etc.

For example, one process for preparing golf ball cores comprising the polymer/monomeric amide modifier composition is to first mix the various core ingredients on a two-roll mill to form slugs of approximately 30-45 g. The slugs are then compression molded in a single step at a temperature between 150° C. to 210° C. for times between 2 and 12 minutes, to both form the core and cure the polymer/monomeric amide modifier composition.

Alternatively, the core may be formed by first injection molding the polymer/monomeric amide modifier formulation into a mold followed by a subsequent compression molding step to complete the curing step. The curing time and conditions in this step would depend on the formulation of the polymer/monomeric amide modifier composition selected.

Alternatively, the core may be formed from the polymer/monomeric amide modifier composition in a single injection molding step in which the polymer/monomeric amide modifier composition is injection molded into a heated mold at a sufficient temperature to induce either partial crosslinking, or to completely crosslink the material, to yield the desired core properties. If the material is partially cured, additional compression molding and/or irradiation steps optionally may be used to complete the curing process and thereby yield the desired core properties.

Similarly in both intermediate layer(s) and outer cover formation, the use of polymer/monomeric amide modifier compositions allows for considerable flexibility in the layer formation steps of golf ball construction.

For instance, finished golf balls may be prepared by initially positioning a solid preformed core in an injection molding cavity followed by uniform injection of the intermediate or cover layer polymer/monomeric amide modifier-containing composition sequentially over the core to produce layers of the required thickness and ultimately golf balls of the required diameter. Again use of a heated injection mold allows the temperature to be controlled sufficient to either partially or fully crosslink the material to yield the desired layer properties. If the material is partially cured, additional compression molding or irradiation steps optionally may be employed to complete the curing process to yield the desired layer properties.

Alternatively, the intermediate and/or cover layers also may be formed around the core or intermediate layer by first forming half shells by injection molding the polymer/polymer modifier compositions followed by a compression molding the half shells about the core or intermediate layer to cure the layers in the final ball.

Alternatively, the intermediate and/or cover layers also may be formed around the core or intermediate layer by first forming half shells by injection molding the polymer/monomeric amide modifier compositions again using a heated injection mold that allows sufficient temperature control to either partially or fully crosslink the material to yield the desired half shell properties layer properties. The resulting fully or partially cured half shells then may be compression molded around the core or core plus intermediate layer. Again, if the half shell is partially cured, the additional compression molding or irradiation steps optionally may be tailored to complete the curing process to yield the desired layer properties.

Finally, outer or intermediate covers comprising the polymer/monomeric amide modifier compositions also may be formed around the cores using conventional compression molding techniques.

In addition, if radiation is used as a cross-linking agent, then the mixture comprising the polymer/monomeric amide and other additives can be irradiated following mixing, during forming into a part such as the core, intermediate layer, or outer cover of a ball, or after forming such part.

The use of the novel blend compositions in the various components of a golf ball such as the core, intermediate layers and/or covers allows for maintaining or increasing C.O.R. while also improving the materials processability.

### EXAMPLES

The following examples are provided to exemplify particular features of working or hypothetical examples. A person of ordinary skill in the art will appreciate that the scope of the invention is not limited to the particular features exemplified.

Tensile Strength, Tensile Elongation, Flexural Modulus, PGA compression, C.O.R., Shore D hardness were conducted on materials and/or golf balls made according to the present disclosure using the test methods as defined below.

Tensile Strength (“TS”), was measured in accordance with ASTM Test D 368.

Tensile Elongation (“TE”) was measured in accordance with ASTM Test D 368.

Flexural Modulus (“FM”) and Flexural Strength (“FS”) were measured in accordance with ASTM Test D 790.

Melt Flow Index (“MFI”) was measured using ASTM D1238 Condition 230° C., 2.16 Kg.

Shore D hardness was measured in accordance with ASTM Test D2240.

The balls were tested for shear resistance by hitting them with a 56 degree sand wedge at a controlled speed. Three trials of each ball type were used for this testing and each ball was hit twice. Each ball was assigned a numerical score from 1 (no visible damage) to 5 (substantial material displaced), and these scores were averaged for each ball type to produce the shear resistance numbers.

Compression is measured by applying a spring-loaded force to the sphere to be examined, with a manual instrument (an “Atti gauge”) manufactured by the Atti Engineering Company of Union City, N.J. This machine, equipped with a Federal Dial Gauge, Model D81-C, employs a calibrated spring under a known load. The sphere to be tested is forced a distance of 0.2 inch (5 mm) against this spring. If the spring, in turn, compresses 0.2 inch, the compression is rated at 100; if the spring compresses 0.1 inch, the compression value is rated as 0. Thus more compressible, softer materials will have lower Atti gauge values than harder, less compressible materials. Compression measured with this instrument is also referred to as PGA compression. The approximate relationship that exists between Atti or PGA compression and Riehle compression can be expressed as:
(Atti or PGA compression)=(160−Riehle Compression).
Thus, a Riehle compression of 100 would be the same as an Atti compression of 60.

Initial velocity of a golf ball after impact with a golf club is governed by the United States Golf Association (“USGA”). The USGA requires that a regulation golf ball can have an initial velocity of no more than 250 feet per second ±2% or 255 feet per second. The USGA initial velocity limit is related to the ultimate distance that a ball may travel (280 yards±6%), and is also related to the coefficient of restitution (“COR”). The coefficient of restitution is the ratio of the relative velocity between two objects after direct impact to the relative velocity before impact. As a result, the COR can vary from 0 to 1, with 1 being equivalent to a completely elastic collision and 0 being equivalent to a completely inelastic collision. Since a ball's COR directly influences the ball's initial velocity after club collision and travel distance, golf ball manufacturers are interested in this characteristic for designing and testing golf balls.

One conventional technique for measuring COR uses a golf ball or golf ball subassembly, air cannon, and a stationary steel plate. The steel plate provides an impact surface weighing about 100 pounds or about 45 kilograms. A pair of ballistic light screens, which measure ball velocity, are spaced apart and located between the air cannon and the steel plate. The ball is fired from the air cannon toward the steel plate over a range of test velocities from 50 ft/s to 180 ft/sec. As the ball travels toward the steel plate, it activates each light screen so that the time at each light screen is measured. This provides an incoming time period proportional to the ball's incoming velocity. The ball impacts the steel plate and rebounds through the light screens, which again measure the time period required to transit between the light screens. This provides an outgoing transit time period proportional to the ball's outgoing velocity. The coefficient of restitution can be calculated by the ratio of the outgoing transit time period to the incoming transit time period, COR=T_{Out}/Tᵢₙ.

### Example 1

A composition was formed comprising DuPont's SURLYN® 9910, an ionomeric thermoplastic resin comprising an ethylene/methacrylic acid copolymer having about 15 weight percent acid, about 58 percent of which is neutralized with zinc ions. SURLYN® 9910 was formulated with various amounts of erucamide [cis-13-docosenoamide, CH₃(CH₂)₇CH═CH(CH₂)₁₁CONH₂] in the form of PROAID® AC 18 E, an unsaturated erucamide having a specific gravity of 0.93 and a melting point of 80° C., and commercially available from Akrochem, of Akron, Ohio. The materials were mixed using a twin-screw extruder. The compositions and material properties of such compositions are provided below in Table 1.

TABLE 1

| | SURLYN ® | PROAID ® | | Material | | | | | Sphere |
|---|---|---|---|---|---|---|---|---|---|
| | 9910 | AC18E | MFI | Hardness | TE | TS | FM | Sphere | Hardness |
| | (pph) | (pph) | (g/10 min.)* | (Shore D) | (%) | (psi) | (kpsi) | COR | (Shore D) |
| 1 | 100 | — | 6.9 | 60 | 66 | 4516 | 54.7 | 0.697 | 65.3 |
| 2 | 100 | 3 | 13.1 | 55 | 100 | 4491 | 35.8 | 0.698 | 59.9 |
| 3 | 100 | 5 | 13 | 52.4 | 109 | 4284 | 32.4 | 0.694 | 58.5 |
| 4 | 100 | 7 | 16.9 | 50.2 | 118 | 4135 | 29.2 | 0.686 | 57 |
| 5 | 100 | 10 | 18.5 | 48.1 | 147 | 3628 | 23.9 | 0.673 | 54.3 |

The test data presented in Table 1 clearly establish that the addition of a monomeric amide polymer composition modifier, such as erucamide, increases MFI and TE, and decreases hardness. Moreover, the COR values are substantially the same. Thus, without any decrease, or a small decrease, in COR, monomeric amidated polymeric composition modifiers provide material design and application development flexibility.

### Example 2

Compositions were formed comprising SURLYN® 8150, 9150, and combinations thereof and various amounts of PROAID® AC 18 E. The materials were mixed using an extruder. The compositions and material properties of such compositions are provided below in Table 2.

TABLE 2

| | | | | | | | | |
|---|---|---|---|---|---|---|---|---|
| SURLYN ® 8150 | 100 | 100 | | | 50 | 50 | 50 | 50 |
| SURLYN ® 9150 | | | 100 | 100 | 50 | 50 | 50 | 50 |
| PROAID ® AC 18E | | 5 | | 5 | | 3 | 5 | 7 |
| (erucamide) (pph) | | | | | | | | |
| TS (kpsi) | 2955 | 3535 | 3109 | 3330 | 3642 | 3613 | 3551 | 3514 |
| TE (%) | 173 | 249 | 181 | 258 | 166 | 214 | 210 | 214 |
| FS (kpsi) | 504 | 347 | 299 | 198 | 515 | 444 | 409 | 383 |
| FM (kpsi) | 61.3 | 44.3 | 34.5 | 23 | 60 | 52.1 | 47.7 | 45.5 |
| Hardness | 62 | 56.4 | 59 | 52.7 | 63 | 58.6 | 58.4 | 56.7 |
| (Shore D) | | | | | | | | |
| Sphere | 164 | 160 | 149 | 140 | 162 | 157 | 159 | 159 |
| Compression | | | | | | | | |
| Sphere C.O.R. | 0.766 | 0.748 | 0.711 | 0.669 | 0.785 | 0.773 | 0.77 | 0.766 |
| Sphere Hardness | 69.9 | 63.8 | 65.1 | 58.3 | 67.4 | 65 | 63.6 | 61.1 |
| (Shore D) | | | | | | | | |

### Example 3

A composition was formed comprising GRILAMID TR90, VESTENAMER 8012, and erucamide. GRILAMID TR90 is commercially available from EMS Chemie and is a copolymer of dodecanedioic acid with 4,4′-methylenebis(2-methylcyclohexanamine) (also known as cyclohexanamine, 4,4′-methylenebis(2-methylcyclohexanamine) having a glass transition temperature (T_{g}) of 155° C., specific gravity of 1.01, flexural modulus of 229 kpsi, flexural strength of 11,900 psi, tensile strength at yield of 8,300 psi, and a tensile elongation of 150% at break. VESTENAMER® 8012 is a polyoctenamer rubber commercially available from Huls AG of Marl, Germany, and through its distributor in the U.S., Creanova Inc. of Somerset, N.J. Two grades of the VESTENAMER® trans-polyoctenamer are commercially available: VESTENAMER 8012 designates a material having a trans-content of approximately 80% (and a cis-content of 20%) with a melting point of approximately 54° C. The compositions and material properties of such compositions are provided below in Table 4.

TABLE 3

| | A | B | C |
|---|---|---|---|
| TR90 | 100 | 100 | 100 |
| Vestenamer 8012 | 10 | 10 | 10 |
| Erucamide | | 1.5 | 3 |
| MFI (g/10 min) | 2.8 | 5.4 | 7.2 |
| SPECIMEN PROPERTIES | | | |
| Tensile Strength (psi) | 5723 | 5593 | 5864 |
| Tensile Elongation (%) | 102 | 119 | 80 |
| Flexural Modulus (kpsi) | 202 | 203 | 209 |
| SPHERE PROPERTIES | | | |
| Shore D Hardness | 70 | 71 | 69 |
| Compression | 173 | 176 | 174 |
| COR | 0.793 | 0.798 | 0.799 |

### Example 4

Balls having a 3-piece construction were made having a cis 1,4-polybutadiene core of 1.48″ diameter and 70 core compression; a mantle having 0.05″ thickness molded with ionomeric resin, HPF 1000 from Du Pont; and a cover having 0.05″ thickness molded with compositions 1, 2, 4, and 5 as provided in TABLE 1.

TABLE 4

| | Ball 1 | Ball 2 | Ball 3 | Ball 4 | Ref. 1 | Ref. 2 | Ref. 3 | Ref. 4 |
|---|---|---|---|---|---|---|---|---|
| Cover | #1 | #2 | #4 | #5 | | | | |
| Composition | | | | | | | | |
| PGA | 97 | 97 | 98 | 100 | 90 | | | |
| Compression | | | | | | | | |
| Cover | 62.1 | 58 | 56.4 | 53.3 | 60 | | | |
| Hardness | | | | | | | | |
| (Shore D) | | | | | | | | |
| Shear-cut | 2.1 | 2.3 | 2.7 | 2.4 | 3.3 | 2.1 | 1.8 | 2 |
| resistance | | | | | | | | |

With reference to Table 4, balls 1-4 were 3-piece balls having a 70 compression core; a mantle having a thickness of 0.05″ with HPF 1000; a cover having a thickness of 0.05″; and the compositions stated in Table 1.

Ref. 1 were 3-piece balls having a 70 compression core; a mantle having a thickness of 0.05″ with HPF 1000; a cover having a thickness of 0.05″, 60 D; with an ionomer blend of high acid ionomer and soft terpolymeric ionomer.

Ref. 2 were 2-piece balls having a 70 compression core; a 0.05″ thickness, 60 Shore D cover with an ionomer blend of high acid ionomer and soft terpolymeric ionomer.

Ref. 3 were Revolution Tour balls sold by Maxfli having a thermoset urethane cover.

Ref. 4 were BlackMAX balls sold by Maxfli having a thermoset urethane cover.

A. Ball #1 vs. Balls #2-#4

The cover hardnesses of Balls #2-#4 were lower than Ball #1 in a wide range, while giving a comparable shear-cut resistance. At the same time, PGA ball compression did not change even with the reduced lowered cover hardnesses.

B. Ref. #1 vs. Balls #2-#4

Balls #2-#4 have the same ball constructions as Ref. 1, except for the cover composition. Ref. #1 has a cover composition comprising a high-acid ionomer with hardness adjusted by the addition of a soft terpolymeric ionomer. The shear-cut result shows that Balls #2-#4 showed a much better shear-cut resistance even with lower or much lower cover hardnesses. In general, the shear-cut resistance of balls having ionomer covers gets worse with decreasing cover hardness.

C. Ref. #2 vs. Balls #2-#4

Ref. #3 has the same cover composition as Ref. #1. In general, 2-piece balls provide a better shear-cut resistance than 3-piece balls with the same cover composition, as shown by comparing Ref. #1 vs. Ref. #2. The shear-cut resistance gets worse as the ionomer cover hardness decreases. Therefore, it is expected that Ref. #2 would show a much better shear-cut resistance than Balls #2-#4. However, Balls #2-#4 still showed comparable shear-cut resistance as Ref. #2, even with a 3-piece construction and much lower cover hardness.

D. Ref. #3-#4 vs. Ball #2-#4

Thermoset urethane is known to be a very durable material, and golf balls having thermoset urethane as a cover provide excellent shear-cut resistance, and in general provides much better results than a thermoplastic resin. Here, Balls #2-#4 still showed a comparable shear-cut resistance to the thermoset urethane covered balls.

In view of the many possible embodiments to which the principles of this disclosure may be applied, it should be recognized that the illustrated embodiments are only preferred examples and should not be taken as limiting the scope of the invention.

### Example 5

This example concerns the addition of erucamide to various golf ball compositions, and compares the physical characteristics of such compositions, and golf balls made using such compositions, to those of a control ball that had no erucamide added. Table 5 below provides a composition of comparison balls numbered 1A, 1B, 2A, and 2B. The golf balls had a cover blend comprising Nucrel 2906 and HG-252 in equal parts. To these compositions were added 10 parts per hundred (pph) AX 3410 (a terpolymer incorporating maleic anhydride). Balls 1A and 1B were control balls that did not include any erucamide. Two parts per hundred erucamide were added to golf ball covers number 2A and 2B.

TABLE 5

| Preferred Specs | 1a | 1b | 2a | 2b |
|---|---|---|---|---|
| Cover Blend* | | | | |
| Nucrel 2906 | 50 | | 50 | |
| HG-252 | 50 | | 50 | |
| AX3410 | 10 | | 10 | |
| % Neutralization | 83 | | 83 | |
| Erucamide | | | 2 | |
| MFI (g/10 min.) @ 230 C. | 9.5 | | 11.6 | |
| Core Size | 1.480 | 1.480 | 1.480 | 1.480 |
| Core Compression | 58 | 71 | 58 | 71 |
| COR | 0.813 | 0.816 | 0.813 | 0.816 |
| Mantled core physicals | | | | |
| Compression | 81 | 77 | 81 | 77 |
| Shore D Hardness | 65.6 | 49.2 | 65.6 | 49.2 |
| COR | 0.836 | 0.826 | 0.836 | 0.826 |
| Ball Physicals | | | | |
| Compression | 81 | 75 | 80 | 76 |
| COR | 0.824 | 0.817 | 0.823 | 0.818 |
| Shore D Hardness | 52.3 | 50.5 | 52.8 | 49.0 |
| Shear Evaluation | 2.9 | 2.5 | 2.9 | 2.7 |

*Materials compounded at 230 C.

Table 5 shows that the melt flow index (MFI) increased from 9.5 grams/10 minutes at 230° C. to 11.6 grams/10 minutes for the balls comprising erucamide. This is a significant increase in the MFI, and hence compositions comprising erucamide are substantially easier to process than compositions that do not include erucamide.

Table 5 also compares other physical characteristics of the balls, including the COR and the Shore D Hardness. Table 5 clearly shows that the addition of erucamide, while increasing the MFI, did not substantially decrease any of the other important ball characteristics. As a result, the results of this example establish that the addition of erucamide is a beneficial addition for processing parameters, but does not substantially deleteriously impact ball physical characteristics.

Based upon prior results, it was determined that the hardness of covers made with compositions comprising erucamide was reduced. For example, Surlyn 9910 is a common material used to make golf ball components, such as golf ball covers. Golf ball covers made using Surlyn 9910 typically have a hardness of about 64-65 Shore D. The addition of about 3 to 5 pph erucamide reduces cover hardness to about 60 Shore D.

The compositions indicated as 3A in Table 6 below had both core and mantel compositions that were identical. However, the cover composition for ball 3A was formed from a blend of Surlyns, primarily Surlyn 9120, 8140, and 8320. This blend typically is used to reduce the hardness of Surlyn 9910. However, using a blend increases the cost and manufacturing complexity. Thus, reducing the hardness of golf ball components comprising Surlyn 9910 without forming blends and with the addition of an amide, such as erucamide, and without compromising other ball characteristics, provides a substantial processing benefit.

Composition 3B used 100% Surlyn, but included 3 pph erucamide to reduce the cover hardness to 60.8 Shore D. The COR of golf balls made using this composition was not substantially reduced, and in fact is identical at 0.827. The sheer-cut resistance of the two balls, namely 2.3 and 2.4 for 3A and 3B respectively, also are substantially identical. Table 6 also provides results for commercially available balls such as Distance Plus, Noodle, Rev. EXT, and BlaxkMAX. The sheer-cut resistance for ball 3B was substantially similar to Distance Plus, and slightly greater than BlakeMAX and Noodle.

TABLE 6

| | | | Distance | | Rev. | |
|---|---|---|---|---|---|---|
| | 3a | 3b | Plus | Noodle | EXT | BlackMAX |
| 1.48″ Core | | | | | | |
| Core Compression | 70 | 70 | | | | |
| Mantle | | | | | | |
| 1.58″ HPF1000 | 100 | 100 | | | | |
| Cover | | | | | | |
| HPC 1043 | | | | | | |
| S9910 | | 100 | | | | |
| S9120 | 30 | | | | | |
| S8140 | 30 | | | | | |
| S8320 | 40 | | | | | |
| color concentrate | 5 pph | 5 pph | | | | |
| Erucamide | | 3 pph | | | | |
| Ball Compression | 85 | 84 | | | | |
| Cover Hardness (D) | 58.9 | 60.8 | | | | |
| C.O.R | 0.827 | 0.827 | | | | |
| Driver speed, mph | 160.4 | 162 | | 158.3 | | 160.2 |
| Driver Spin, rpm | 3051 | 2988 | | 2908 | | 2921 |
| Shear-cut | 2.3 | 2.4 | 2.2 | 1.8 | 3.7 | 1.9 |
| resistance | | | | | | |

The present invention has been described with reference to certain embodiments. A person of ordinary skill in the art will appreciate that the scope of the invention is not limited to these exemplary features.

We claim:

1. A composition, comprising:
at least a first polymeric material selected from the group consisting of synthetic and natural rubbers, thermoplastic elastomers, metallocene catalyzed polymer, polyolefins, halogenated polyolefins, halogenated polyethylene, unimodal ethylene/carboxylic acid copolymers, unimodal ethylene/carboxylic acid/carboxylate terpolymers, bimodal ethylene/carboxylic acid copolymers, bimodal ethylene/carboxylic acid/carboxylate terpolymers, bimodal ionomers, modified bimodal ionomers, thermoplastic and thermoset polyurethanes, polyurethane ionomers, polyalkenamers, thermoplastic and thermoset polyureas, polyamides, copolyamides, polyesters, copolyesters, polycarbonates, polyphenylene oxides, polyphenylene sulfides, diallyl phthalate polymers, polyimides, polyvinyl chlorides, polyamide-ionomers, polyvinyl alcohols, polyarylates, polyacrylates, polyphenylene ethers, impact-modified polyphenylene ethers, polystyrenes, high impact polystyrenes, acrylonitrile-butadiene-styrene copolymers, styrene-acrylonitriles (SAN), acrylonitrile-styrene-acrylonitriles, styrene-maleic anhydride (S/MA) polymers, styrenic copolymers, functionalized styrenic copolymers, functionalized styrenic terpolymers, styrenic terpolymers, ethylene-propylene copolymer (EPDM), cellulosic polymers, liquid crystal polymers (LCP), ethylene-vinyl acetate copolymers (EVA), polyureas, and polysiloxanes and any and all combinations thereof; and
greater than 0.5 pph of a monomeric aliphatic, alicyclic or aromatic amide.

2. The composition according to claim 1 where the polymer is a partially or fully neutralized copolymeric or terpolymeric ionomer.

3. The composition according to claim 1 comprising greater than 0.5 weight percent to about 50 weight percent aliphatic, alicyclic, or aromatic monomeric amide.

4. The composition according to claim 1 comprising a fatty acid aliphatic amide.

5. The composition according to claim 1 where the aliphatic, alicyclic, or aromatic monomeric amide is a primary amide, a secondary amide, a bis amide, or combinations thereof.

6. The composition according to claim 1 where the monomeric amide is unsaturated.

7. The composition according to claim 7 where double bonds in the amide are substantially all trans or substantially all cis.

8. The composition according to claim 1 where the amide is saturated.

9. The composition according to claim 1 where the aliphatic, alicyclic and/or aromatic amide has from about 5 to about 100 carbon atoms.

10. The composition according to claim 1 where the amide is stearamide, behenamide, oleamide, erucamide, stearyl erucamide, erucyl erucamide, oleyl palimitamide, stearyl stearamide, erucyl stearamide, N,N′ethylenebisstearamide, N,N′ethylenebisolamide, carnauba wax amide, rice wax amide, montan wax amide, and combinations of any two or more of such compounds.

11. The composition according to claim 1 further comprising a cross-linking agent selected from sulfur compounds, peroxides, azides, maleimides, e-beam radiation, gamma-radiation, a co-cross-linking agent comprising zinc or magnesium salts of an unsaturated fatty acid having from about 3 to about 8 carbon atoms, a base resin, a peptizer, an accelerator, a UV stabilizer, a photostabilizer, a photoinitiator, a co-initiator, an antioxidant, a colorant, a dispersant, a mold release agent, a processing aid, a fiber, a filler including a density adjusting filler, a nano-filler, an inorganic filler, an organic filler, and combinations thereof.

12. A golf ball having at least one component comprising a composition comprising at least one polymeric material useful for making a golf ball and an effective amount of a monomeric aliphatic or aromatic amide.

13. The golf ball according to claim 12 where the at least one polymeric material is a polyamide, an ionomer, a polyalkenamer or combinations thereof.

14. The composition according to claim 12 where the effective amount is from about 0.5 weight percent to about 50 weight percent based on the weight of the polymer.

15. The golf ball according to claim 12 where the amide is a fatty acid aliphatic amide.

16. The golf ball according to claim 12 where the monomeric amide is unsaturated, and where double bonds in the amide are substantially all trans or substantially all cis.

17. The golf ball according to claim 12 where the amide is saturated.

18. The golf ball according to claim 12 where the amide has from about 10 to about 25 carbon atoms.

19. The golf ball according to claim 12 where the monomeric amide is stearamide, behenamide, oleamide, erucamide, stearyl erucamide, erucyl erucamide, oleyl palimitamide, stearyl stearamide, erucyl stearamide, N,N′ethylenebisstearamide, N,N′ethylenebisolamide, carnauba wax amide, rice wax amide, montan wax amide, and combinations of any two or more of such amidated compounds.

20. The golf ball according to claim 12 where the composition further comprises a cross-linking agent selected from sulfur compounds, peroxides, azides, maleimides, e-beam radiation, gamma-radiation, a co-cross-linking agent comprising zinc or magnesium salts of an unsaturated fatty acid having from about 3 to about 8 carbon atoms, a base resin, a peptizer, an accelerator, a UV stabilizer, a photostabilizer, a photoinitiator, a co-initiator, an antioxidant, a colorant, a dispersant, a mold release agent, a processing aid, a fiber, a filler including a density adjusting filler, a nano-filler, an inorganic filler, an organic filler, and combinations thereof.

21. The golf ball according to claim 12 having a core comprising the composition.

22. The golf ball according to claim 12 having a core, one or more intermediate layers and a cover layer, the core having a PGA compression of from about 30 to about 190, the one or more intermediate layers or cover layer having a thickness of from about 0.01 to about 0.20 inch, and the one or more intermediate layers or cover layer having a Shore D hardness of greater than about 25.

23. The golf ball according to claim 12 having a cover layer formed from a composition comprising a reaction product of (a) diol(s), polyol(s), or combinations thereof; (b) diisocyanate(s), polyisocyanate(s), or combinations thereof; (c) diamine(s), polyamine(s), or combinations thereof; or any combinations of (a), (b), and (c).

24. The golf ball according to claim 12 having a cover layer that is formed by a method comprising:
mixing at least one component A that is a monomer, oligomer, prepolymer, or polymer comprising at least 5% by weight of anionic functional groups; at least one component B that is a monomer, oligomer, prepolymer, or polymer comprising less by weight of anionic functional groups than the weight percentage of anionic functional groups of the at least one component A; and at least one component C that is a metal cation, thereby forming a first composition, and
melt-processing the first composition to produce a reaction product of the anionic functional groups of the at least one component A and the at least one component C to form the polymer blend composition, wherein the polymer blend composition incorporates an in-situ-formed pseudo-crosslinked network of the at least one component A in the presence of the at least one component B.

25. The golf ball according to claim 12 comprising a core, at least one intermediate layer and a cover, at least one of the core, intermediate layer and cover being formed from a composition comprising a polymer useful for making a golf ball and from about 0.1 to about 50 weight percent of a monomeric aliphatic, alicyclic or aromatic amide.

26. The golf ball according to claim 25 where the amide is stearamide, behenamide, oleamide, erucamide, stearyl erucamide, erucyl erucamide, oleyl palimitamide, stearyl stearamide, erucyl stearamide, N,N′ethylenebisstearamide, N,N′ethylenebisolamide, carnauba wax amide, rice wax amide, montan wax amide, and combinations of any two or more of such compounds.

27. The three-piece golf ball according to claim 26 comprising a cover comprising a polymer selected from thermoset polyurethanes, thermoset polyureas, thermoplastic polyurethanes, thermoplastic polyureas, metallocene catalyzed polymers, unimodal ionomers, bimodal ionomers, modified unimodal ionomers, modified bimodal ionomers, thermoplastic elastomers, polyolefins, polyalkenamers, polyesters, polyetheresters, polycarbonates, polyamides, polyetheramides, and any and all combinations thereof.

28. The golf ball according to claim 12, comprising:
a rubber-based core having a center; and
an inner intermediate layer, an outer intermediate layer, and a cover, at least one of the inner layer, outer intermediate layer or cover comprising a polymer useful for making such layer and from about 0.1 to about 50 weight percent of a monomeric aliphatic or aromatic amide.

29. The four-piece golf ball according to claim 28 where the amide is a fatty acid aliphatic amide.

30. A method for forming a golf ball, comprising:
providing a composition comprising a polymer material useful for forming a golf ball and an effective amount of a monomeric aliphatic or aromatic amide; and
forming at least one component of a golf ball comprising the composition.

31. The method according to claim 30 where the polymer, or a polymer precursor, is selected from synthetic and natural rubbers, thermoplastic and thermoset polyurethanes, thermoplastic and thermoset polyureas, unimodal ethylene/carboxylic acid copolymers, unimodal ethylene/carboxylic acid/carboxylate terpolymers, bimodal ethylene/carboxylic acid copolymers, bimodal ethylene/carboxylic acid/carboxylate terpolymers, unimodal ionomers, bimodal ionomers, modified unimodal ionomers, modified bimodal ionomers, thermoplastic polyurethanes, thermoplastic polyureas, polyamides, copolyamides, polyesters, copolyesters, polycarbonates, polyolefins, halogenated polyolefins, halogenated polyethylenes, polyphenylene oxide, polyphenylene sulfide, diallyl phthalate polymer, polyimides, polyvinyl chloride, polyamide-ionomer, polyurethane-ionomer, polyvinyl alcohol, polyarylate, polyacrylate, polyphenylene ether, impact-modified polyphenylene ether, polystyrene, high impact polystyrene, acrylonitrile-butadiene-styrene copolymer styrene-acrylonitrile (SAN), acrylonitrile-styrene-acrylonitrile, styrene-maleic anhydride (S/MA) polymer, styrenic copolymer, functionalized styrenic copolymer, functionalized styrenic terpolymer, styrenic terpolymer, cellulose polymer, liquid crystal polymer (LCP), ethylene-propylene-diene terpolymer (EPDM), ethylene-vinyl acetate copolymers (EVA), ethylene-propylene copolymer, ethylene vinyl acetate, polyurea, polysiloxane, and said polymer further comprising a compound having a general formula (R₂N)ₘ—R′—(X(O)ₙOR_{y})ₘ, wherein R is selected from the group consisting of hydrogen, one or more C₁-C₂₀ aliphatic systems, one or more cycloaliphatic systems, one or more aromatic systems, R′ is a bridging group comprising one or more unsubstituted C₁-C₂₀ straight chain or branched aliphatic or alicyclic groups, one or more substituted straight chain or branched aliphatic or alicyclic groups, one or more aromatic groups, one or more oligomers each containing up to 12 repeating units, and when X is C or S or P, m is 1-3, when X=C, n=1 and y=1, when X=S, n=2 and y=1, and when X=P, n=2 and y=2, and any and all combinations of such materials.

32. The method according to claim 30 where the amide is a fatty acid aliphatic amide.

33. The method according to claim 30 where the amide is unsaturated.

34. The method according to claim 33 where double bonds in the amide are substantially all trans or substantially all cis.

35. The method according to claim 30 where the amide is saturated.

36. The method according to claim 30 where the amide is stearamide, behenamide, oleamide, erucamide, stearyl erucamide, erucyl erucamide, oleyl palimitamide, stearyl stearamide, erucyl stearamide, N,N′ethylenebisstearamide, N,N′ethylenebisolamide, carnauba wax amide, rice wax amide, montan wax amide, and combinations of any two or more of such compounds.

37. The method according to claim 30 where the composition further comprises a cross-linking agent selected from sulfur compounds, peroxides, azides, maleimides, e-beam radiation, gamma-radiation, a co-cross-linking agent comprising zinc or magnesium salts of an unsaturated fatty acid having from about 3 to about 8 carbon atoms, a base resin, a peptizer, an accelerator, a UV stabilizer, a photostabilizer, a photoinitiator, a co-initiator, an antioxidant, a colorant, a dispersant, a mold release agent, a processing aid, a fiber, a filler including a density adjusting filler, a nano-filler, an inorganic filler, an organic filler, and combinations thereof.

38. The method according to claim 30 further comprising forming a cover having a cover composition formed by a method comprising:
mixing at least one component A that is a monomer, oligomer, prepolymer, or polymer comprising at least 5% by weight of anionic functional groups; at least one component B that is a monomer, oligomer, prepolymer, or polymer comprising less by weight of anionic functional groups than the weight percentage of anionic functional groups of the at least one component A; and at least one component C that is a metal cation, thereby forming a first composition; and
melt-processing the first composition to produce a reaction product of the anionic functional groups of the at least one component A and the at least one component C to form the polymer blend composition, wherein the polymer blend composition incorporates an in-situ-formed pseudo-crosslinked network of the at least one component A in the presence of the at least one component B.

39. A golf ball made according to the method of claim 30.

40. A method for using an amide-modified polymer or polymer precursor to make a golf ball composition, comprising:
providing a first composition comprising a polymer or polymer precursor having an effective amount of a monomeric aliphatic or aromatic amide;
providing at least a second composition; and
combining the first and second compositions to form a third composition useful for making at least one component of a golf ball.

41. The method according to claim 40 where the second composition comprises a polymer or polymer precursor useful for forming at least one component of a golf ball comprising the second composition.

42. The method according to claim 40 where the effective amount is from about 0.1 to about 50 weight percent relative to the weight of the polymer or polymer precursor.

43. The method according to claim 40 where the polymer or polymer precursor of the first composition is selected from synthetic and natural rubbers, thermoplastic and thermoset polyurethanes, thermoplastic and thermoset polyureas, unimodal ethylene/carboxylic acid copolymers, unimodal ethylene/carboxylic acid/carboxylate terpolymers, bimodal ethylene/carboxylic acid copolymers, bimodal ethylene/carboxylic acid/carboxylate terpolymers, unimodal ionomers, bimodal ionomers, modified unimodal ionomers, modified bimodal ionomers, thermoplastic polyurethanes, thermoplastic polyureas, polyamides, copolyamides, polyesters, copolyesters, polycarbonates, polyolefins, halogenated polyolefins, halogenated polyethylenes, polyphenylene oxide, polyphenylene sulfide, diallyl phthalate polymer, polyimides, polyvinyl chloride, polyamide-ionomer, polyurethane-ionomer, polyvinyl alcohol, polyarylate, polyacrylate, polyphenylene ether, impact-modified polyphenylene ether, polystyrene, high impact polystyrene, acrylonitrile-butadiene-styrene copolymer styrene-acrylonitrile (SAN), acrylonitrile-styrene-acrylonitrile, styrene-maleic anhydride (S/MA) polymer, styrenic copolymer, functionalized styrenic copolymer, functionalized styrenic terpolymer, styrenic terpolymer, cellulose polymer, liquid crystal polymer (LCP), ethylene-propylene-diene terpolymer (EPDM), ethylene-vinyl acetate copolymers (EVA), ethylene-propylene copolymer, ethylene vinyl acetate, polyurea, polysiloxane, and said polymer further comprising a compound having a general formula (R₂N)ₘ—R′—(X(O)ₙOR_{y})ₘ, wherein R is selected from the group consisting of hydrogen, one or more C₁-C₂₀ aliphatic systems, one or more cycloaliphatic systems, one or more aromatic systems, R′ is a bridging group comprising one or more unsubstituted C₁-C₂₀ straight chain or branched aliphatic or alicyclic groups, one or more substituted straight chain or branched aliphatic or alicyclic groups, one or more aromatic groups, one or more oligomers each containing up to 12 repeating units, and when X is C or S or P, m is 1-3, when X=C, n=1 and y=1, when X=S, n=2 and y=1, and when X=P, n=2 and y=2, and any and all combinations of such materials.

44. The method according to claim 40 where the amide is a fatty acid aliphatic amide.

45. The method according to claim 40 where the amide is unsaturated.

46. The method according to claim 40 where the amide is saturated.

47. The method according to claim 40 where the amide is stearamide, behenamide, oleamide, erucamide, stearyl erucamide, erucyl erucamide, oleyl palimitamide, stearyl stearamide, erucyl stearamide, N,N′ethylenebisstearamide, N,N′ethylenebisolamide, carnauba wax amide, rice wax amide, montan wax amide, and combinations of any two or more of such compounds.
